(19) United States
(12) Patent Application Publication
(10) Pub. No.: US 2026/0089757 A1
(43) Pub. Date: Mar. 26, 2026

(54) COMMUNICATION METHOD AND APPARATUS

(71) Applicant: HUAWEI TECHNOLOGIES CO., LTD., Shenzhen (CN)

(72) Inventors: Yiyan Zhang, Xi'an (CN); Rui Du, Singapore (SG); Li Sun, Shenzhen (CN); Gerile Naren, Shenzhen (CN); Mengshi Hu, Shenzhen (CN); Xiao Han, Shenzhen (CN); Peng Liu, Shenzhen (CN); Zhuqing Tang, Shenzhen (CN)

(21) Appl. No.: 19/410,090

(22) Filed: Dec. 5, 2025

Related U.S. Application Data
(63) Continuation of application No. PCT/CN2024/079418, filed on Feb. 29, 2024.

(30) Foreign Application Priority Data
Jun. 6, 2023 (CN) 202310666400.5

(51) Int. Cl. H04W 74/0816; H04B 7/06; H04W 24/10

(52) U.S. Cl. CPC H04W 74/0816; H04B 7/0639; H04W 24/10

(57) ABSTRACT

Embodiments of this application provide a communication method and apparatus. The method includes: A first apparatus determines weighting information N streams of sensing sequences of a second apparatus, where N is a positive integer; and the first apparatus sends a first sensing frame, where the first sensing frame includes the weighting information. After receiving the first sensing frame, the second apparatus may weight the N streams of sensing sequences of the second apparatus based on the weighting information, of the N streams of sensing sequences, in the first sensing frame, and then perform transmission.

### CROSS-REFERENCE TO RELATED APPLICATIONS

This application is a continuation of International Application No. PCT/CN2024/079418, filed on Feb. 29, 2024, which claims priority to Chinese Patent Application No. 202310666400.5, filed on Jun. 6, 2023. The disclosure of the aforementioned applications are hereby incorporated by reference in their entireties.

### TECHNICAL FIELD

This application relates to the field of communication technologies, and in particular, to a communication method and apparatus.

### BACKGROUND

In daily life, a signal sent by a wireless fidelity (wireless fidelity, Wi-Fi) device is generally received after being reflected, diffracted, and scattered by various obstacles. A surrounding environment may be inferred and sensed by analyzing a wireless signal such as channel state information (channel state information, CSI) affected by various obstacles, and therefore a wireless local area network (wireless local area network, WLAN) sensing technology is derived.

In a current solution, for example, in 802.11bf, a plurality of sensing procedures for sensing in a WLAN system are supported, and include a “trigger-based sensing (TB Sensing)” sensing mode. The sensing mode is initiated by an access point (access point, AP), where the AP may be referred to as a sensing initiator (sensing initiator, SI), and responded by one or more non-AP stations (Stations, STAs) for sensing participation, where each STA may be referred to as a sensing responder (sensing responder, SR).

A TB sensing solution includes a “sensing measurement setup” procedure and a “trigger frame sounding (TF Sounding)” sensing procedure. In the “sensing measurement setup” procedure, an AP separately sends a sensing measurement setup request to a STA and receives a sensing measurement setup response. During this period, sensing measurement is set up, and related information is configured and negotiated. In the “trigger frame sounding (TF Sounding)” sensing procedure, one or more SRs (responders) send pilot information to an SI (initiator) to implement sensing, or one SR (responder) sends pilot information to an SR (responder) to implement sensing.

However, in the current TB sensing solution, the pilot information for channel estimation to implement a sensing task is public. Therefore, when sensing is performed between the AP and the STA, the public pilot information may be received by a third-party listener to perform channel estimation based on the pilot information to obtain sensing content (or sensing information). As a result, user privacy information in the sensing content may be exposed to the third party due to sensing. In view of this, currently, a solution is urgently needed to effectively resolve leakage of sensing information in sensing measurement, and further avoid leakage of user privacy information.

### SUMMARY

Embodiments of this application provide a communication method and apparatus, to effectively resolve leakage of sensing information in sensing measurement, and further avoid leakage of user privacy information.

According to a first aspect, an embodiment of this application provides a communication method. The method may be performed by a first apparatus, or may be performed by a chip or a chip system corresponding to the first apparatus. This is not limited. The method may specifically include: The first apparatus determines weighting information N streams of sensing sequences of a second apparatus, where N is a positive integer; and the first apparatus sends a first sensing frame, where the first sensing frame includes the weighting information.

For example, the first apparatus may be an access point (AP), and the second apparatus may be a non-access point station (non-AP STAT). The first sensing frame may be a sensing sounding trigger frame in a sensing measurement process.

In this solution of this application, the first apparatus determines the weighting information of the N streams of sensing sequences of the second apparatus, where N is a positive integer, and sends the weighting information to the second apparatus by using the first sensing frame. The second apparatus may weight the N streams of sensing sequences of the second apparatus based on the weighting information, of the N streams of sensing sequences, in the first sensing frame, and then perform transmission. This can effectively avoid leakage of sensing information.

In a possible implementation, before the first apparatus determines the weighting information of the N streams of sensing sequences of the second apparatus, the method further includes: The first apparatus sends a request message to the second apparatus, where the request message is used to request to set up sensing measurement, and the request message includes at least one sensing subelement, and each sensing subelement corresponds to a weighting matrix.

In this embodiment of this application, the first apparatus serves as a sensing initiator, and the second apparatus serves as a sensing responder.

In this implementation, in a sensing measurement setup phase, the first apparatus may indicate (or transmit) the predefined weighting matrix to the second apparatus, so that when the first apparatus subsequently indicates, in an implicit manner (namely, a secure manner) to the second apparatus, weighting information used by each stream of sensing sequence, the second apparatus can effectively and accurately learn of the weighting information and implement weighted transmission.

In a possible implementation, the sensing subelement includes a weighting matrix indication field, and the weighting matrix indication field indicates the weighting matrix.

In this implementation, each sensing subelement in the sensing measurement setup request message may indicate the weighting matrix.

In a possible implementation, the weighting matrix field includes X bits, X is a positive integer, the X bits include three parts, a first part indicates a weighting matrix of 2×2, a second part indicates a weighting matrix of 4×4, and the second part and a third part jointly indicate a weighting matrix of 8×8.

In this implementation, each sensing subelement can effectively indicate a plurality of predefined weighting matrices.

In a possible implementation, before the first apparatus determines the weighting information of the N streams of sensing sequences of the second apparatus, the method further includes: The first apparatus sends a request message to the second apparatus, where the request message is used to request to set up sensing measurement, and the request message includes at least one sensing subelement, and each sensing subelement corresponds to a phase rotation codebook of a sensing sequence. In this embodiment of this application, the first apparatus serves as a sensing initiator, and the second apparatus serves as a sensing responder.

In this implementation, in a sensing measurement setup phase, the first apparatus may indicate (or transmit) the predefined phase rotation codebook of the sensing sequence to the second apparatus, so that the second apparatus can subsequently implement effective weighted transmission based on the phase rotation codebook of the sensing sequence.

In a possible implementation, the sensing subelement includes a codebook indication field, and the codebook indication field indicates the phase rotation codebook of the sensing sequence.

In this implementation, each sensing subelement in the sensing measurement setup request message may indicate the phase rotation codebook of the sensing sequence.

In a possible implementation, the codebook indication field includes Y bits, the Y bits include L groups of bits, each group of bits indicates coding of one phase rotation manner, and Y and L are positive integers.

For example, coding of one phase rotation manner may correspond to one phase shift weight value or an index of the phase shift weight value. In this embodiment of this application, coding of the phase rotation manner may be considered as a weight value, a weighting value, a weight index, or the like for weighting a symbol.

In this implementation, each sensing subelement can effectively indicate coding of a plurality of phase rotation manners.

In a possible implementation, the request message further includes first indication information, and the first indication information indicates to use a weighted collaborative sensing mode. For example, the first indication information is located in a sensing measurement parameters element in the sensing measurement request frame.

In this implementation, the first apparatus indicates, to the second apparatus, to use the weighted collaborative sensing mode, to ensure to subsequently support weighted collaborative sensing.

In a possible implementation, the method further includes: The first apparatus receives a response message from the second apparatus, where the response message indicates that the second apparatus supports to use the weighted collaborative sensing mode.

In this implementation, the first apparatus is enabled to learn of that the second apparatus supports to use the weighted collaborative sensing mode, to ensure that the second apparatus can effectively perform weighted collaborative sensing subsequently.

In a possible implementation, before the first apparatus sends the first sensing frame, the method further includes: The first apparatus sends a second sensing frame to the second apparatus, where the second sensing frame includes second indication information, and the second indication information indicates to perform weighted transmission on the sensing sequence. For example, the second sensing frame is a sensing voting trigger frame, and the second indication information is information about a reserved bit in the sensing voting trigger frame.

In this implementation, the second apparatus may be enabled to weight the sent sensing sequence and then perform transmission, to ensure security of sensing sequence transmission.

In a possible implementation, the weighting information includes N groups of bits, each group of bits indicates information about a target weighting sequence used by one stream of sensing sequence in the N streams, and the target weighting sequence corresponds to one row of the weighting matrix.

In this implementation, the second apparatus may effectively weight each stream of sensing sequence by using each stream of target weighting sequence.

In a possible implementation, the weighting information includes M groups of bits, each group of bits indicates a phase rotation value of a sensing symbol in one stream of sensing sequence in the N streams, and M is a positive integer greater than 1.

In this embodiment of this application, in a sensing measurement setup process, the phase rotation codebook indicated by the request message includes the M groups of bits.

In this implementation, the second apparatus may effectively weight each sensing symbol in each stream of sensing sequence by using the phase rotation value of each sensing symbol in each stream.

In a possible implementation, the sensing symbol is weighted by using an 8 phase shift keying 8PSK modulation scheme.

In this implementation, the sensing symbol in the sensing sequence is effectively weighted, to ensure security of subsequent transmission.

In a possible implementation, the first sensing frame is an SR2SI sounding trigger frame, the first apparatus is a sensing receiver, and the second apparatus is a sensing transmitter.

In a possible implementation, the first sensing frame is an SR2SR sounding trigger frame, the first sensing frame further includes first information, and the first information indicates but is not limited to indicating one or more of the following: the quantity N of streams of the sensing sequences transmitted by the second apparatus, and identifier (for example, ID) information corresponding to the N streams.

In this implementation, the SR at a sensing receiver can effectively learn of the weighting information of the N streams of sensing sequences of the second apparatus.

In a possible implementation, the first apparatus is an access point AP, and the second apparatus is a non-access point station STA.

According to a second aspect, an embodiment of this application provides a communication method. The method may be performed by a first apparatus, or may be performed by a chip or a chip system corresponding to the first apparatus. This is not limited. The method may specifically include: The first apparatus sends a request message to a second apparatus, where the request message is used to request to set up sensing measurement, the request message includes at least one sensing subelement, and each sensing subelement corresponds to a weighting matrix, or each sensing subelement corresponds to a phase rotation codebook of a sensing sequence; and the first apparatus receives a response message from the second apparatus.

In this embodiment of this application, in a sensing measurement setup process, the first apparatus effectively exchanges the predefined weighting matrix or phase rotation codebook of the sensing sequence with the second apparatus, so that when the first apparatus subsequently indicates, in an implicit manner (namely, a secure manner) to the second apparatus, weighting information used by each stream of sensing sequence, the second apparatus can effectively and accurately learn of the weighting information and implement weighted transmission.

In a possible implementation, the sensing subelement includes a weighting matrix indication field, and the weighting matrix indication field indicates the corresponding weighting matrix.

In this implementation, each sensing subelement in the sensing measurement setup request message may indicate the weighting matrix.

In a possible implementation, the weighting matrix field includes X bits, X is a positive integer, the X bits include three parts, a first part indicates a weighting matrix of 2×2, a second part indicates a weighting matrix of 4×4, and the second part and a third part jointly indicate a weighting matrix of 8×8.

In this implementation, each sensing subelement can effectively indicate a plurality of predefined weighting matrices.

In a possible implementation, the sensing subelement includes a codebook indication field, and the codebook indication field indicates the phase rotation codebook of the sensing sequence.

In this implementation, each sensing subelement in the sensing measurement setup request message may indicate the phase rotation codebook of the sensing sequence.

In a possible implementation, the codebook indication field includes Y bits, the Y bits include L groups of bits, each group of bits indicates coding of one phase rotation manner, and Y and L are positive integers.

For example, coding of one phase rotation manner may correspond to one phase shift weight value or an index of the phase shift weight value. In this embodiment of this application, coding of the phase rotation manner may be considered as a weight value, a weighting value, a weight index, or the like for weighting a symbol.

In this implementation, each sensing subelement can effectively indicate coding of a plurality of phase rotation manners.

In a possible implementation, the request message further includes first indication information, and the first indication information indicates to use a weighted collaborative sensing mode. For example, the first indication information is located in a sensing measurement parameters element in the sensing measurement request frame.

In this implementation, the first apparatus indicates, to the second apparatus, to use the weighted collaborative sensing mode, to ensure to subsequently support weighted collaborative sensing.

In a possible implementation, the method further includes: The first apparatus receives a response message from the second apparatus, where the response message indicates that the second apparatus supports to use the weighted collaborative sensing mode.

In this implementation, the first apparatus is enabled to learn of that the second apparatus supports to use the weighted collaborative sensing mode, to ensure that the second apparatus can effectively perform weighted collaborative sensing subsequently.

According to a third aspect, an embodiment of this application provides a communication method. The method may be performed by a second apparatus, or may be performed by a chip or a chip system corresponding to the second apparatus. This is not limited. The method may specifically include: The second apparatus receives a first sensing frame from a first apparatus, where the first sensing frame includes weighting information N streams of sensing sequences of the second apparatus, and N is a positive integer; the second apparatus separately weights the N streams of sensing sequences based on the weighting information, to obtain the N streams of weighted sensing sequences; and the second apparatus sends the N streams of weighted sensing sequences.

For example, the first apparatus may be an access point (AP), and the second apparatus may be a non-access point station (non-AP STAT). The first sensing frame may be a sensing sounding trigger frame in a sensing measurement process.

In this solution of this application, the first apparatus determines the weighting information of the N streams of sensing sequences of the second apparatus, where N is a positive integer, and sends the weighting information to the second apparatus by using the first sensing frame. The second apparatus may weight the N streams of sensing sequences of the second apparatus based on the weighting information, of the N streams of sensing sequences, in the first sensing frame, and then perform transmission. This can effectively avoid leakage of sensing information.

In a possible implementation, before the second apparatus receives the first sensing frame from the first apparatus, the method further includes: The second apparatus receives a request message from the second apparatus, where the request message is used to request to set up sensing measurement, the request message includes at least one sensing subelement, and each sensing subelement corresponds to a weighting matrix. In this embodiment of this application, the first apparatus is a sensing initiator, and the second apparatus is a sensing responder.

In this implementation, in a sensing measurement setup phase, the first apparatus may indicate (or transmit) the predefined weighting matrix to the second apparatus, so that when the first apparatus subsequently indicates, in an implicit manner (namely, a secure manner) to the second apparatus, weighting information used by each stream of sensing sequence, the second apparatus can effectively and accurately learn of the weighting information and implement weighted transmission.

In a possible implementation, the sensing subelement includes a weighting matrix indication field, and the weighting matrix indication field indicates the corresponding weighting matrix.

In this implementation, each sensing subelement in the sensing measurement setup request message may indicate the weighting matrix.

In a possible implementation, the weighting matrix field includes X bits, X is a positive integer, the X bits include three parts, a first part indicates a weighting matrix of 2×2, a second part indicates a weighting matrix of 4×4, and the second part and a third part jointly indicate a weighting matrix of 8×8.

In this implementation, each sensing subelement can effectively indicate a plurality of predefined weighting matrices.

In a possible implementation, before the second apparatus receives the first sensing frame from the first apparatus, the method further includes: The second apparatus receives a request message from the second apparatus, where the request message is used to request to set up sensing measurement, the request message includes at least one sensing subelement, and each sensing subelement corresponds to a phase rotation codebook of a sensing sequence. In this embodiment of this application, the first apparatus is a sensing initiator, and the second apparatus is a sensing responder.

In this implementation, in a sensing measurement setup phase, the first apparatus may indicate (or transmit) the predefined phase rotation codebook of the sensing sequence to the second apparatus, so that the second apparatus can subsequently implement effective weighted transmission based on the phase rotation codebook of the sensing sequence.

In a possible implementation, the sensing subelement includes a codebook indication field, and the codebook indication field indicates the phase rotation codebook of the sensing sequence.

In this implementation, each sensing subelement in the sensing measurement setup request message may indicate the phase rotation codebook of the sensing sequence.

In a possible implementation, the codebook indication field includes Y bits, the Y bits include L groups of bits, each group of bits indicates coding of one phase rotation manner, and Y and L are positive integers.

For example, coding of one phase rotation manner may correspond to one phase shift weight value or an index of the phase shift weight. In this embodiment of this application, coding of the phase rotation manner may be considered as a weight value, a weighting value, a weight index, or the like for weighting a symbol.

In this implementation, each sensing subelement can effectively indicate coding of a plurality of phase rotation manners.

In a possible implementation, the request message further includes first indication information, and the first indication information indicates to use a weighted collaborative sensing mode. For example, the first indication information is located in a sensing measurement parameters element in the sensing measurement request frame.

In this implementation, the first apparatus indicates, to the second apparatus, to use the weighted collaborative sensing mode, to ensure to subsequently support weighted collaborative sensing.

In a possible implementation, the method further includes: The second apparatus sends a response message to the first apparatus, where the response message indicates that the second apparatus supports to use the weighted collaborative sensing mode.

In this implementation, the first apparatus is enabled to learn of that the second apparatus supports to use the weighted collaborative sensing mode, to ensure that the second apparatus can effectively perform weighted collaborative sensing subsequently.

In a possible implementation, before the second apparatus receives the first sensing frame from the first apparatus, the method further includes: The second apparatus receives a second sensing frame from the second apparatus, where the second sensing frame includes second indication information, and the second indication information indicates to perform weighted transmission on the sensing sequence. For example, the second sensing frame is a sensing voting trigger frame, and the second indication information is information about a reserved bit in the sensing voting trigger frame.

In this implementation, the second apparatus may be enabled to weight the sent sensing sequence and then perform transmission, to ensure security of sensing sequence transmission.

In a possible implementation, the weighting information includes N groups of bits, each group of bits indicates information about a target weighting sequence used by one stream of sensing sequence in the N streams, and the target weighting sequence corresponds to one row of the weighting matrix. In this implementation, the second apparatus may effectively weight each stream of sensing sequence by using each stream of target weighting sequence.

In a possible implementation, the weighting information includes M groups of bits, each group of bits indicates a phase rotation value of a sensing symbol in one stream of sensing sequence in the N streams, and M is a positive integer greater than 1.

In this embodiment of this application, in a sensing measurement setup process, the phase rotation codebook indicated by the request message includes the M groups of bits.

In this implementation, the second apparatus may effectively weight each sensing symbol in each stream of sensing sequence by using the phase rotation value of each sensing symbol in each stream.

In a possible implementation, the sensing symbol is weighted by using an 8 phase shift keying 8PSK modulation scheme.

In this implementation, the sensing symbol in the sensing sequence is effectively weighted, to ensure security of subsequent transmission.

In a possible implementation, the first sensing frame is an SR2SI sounding trigger frame, the first apparatus is a sensing receiver, and the second apparatus is a sensing transmitter.

In a possible implementation, the first sensing frame is an SR2SR sounding trigger frame, the first sensing frame further includes first information, and the first information indicates one or more of the following: the quantity N of streams of the sensing sequences transmitted by the second apparatus, and identifier information corresponding to the N streams.

In this implementation, the SR at a sensing receiver can effectively learn of the weighting information of the N streams of sensing sequences of the second apparatus.

According to a fourth aspect, an embodiment of this application provides a communication method. The method may be performed by a third apparatus, or may be performed by a chip or a chip system corresponding to the third apparatus. This is not limited. The method may specifically include: The third apparatus receives a first sensing frame from a first apparatus, where the first sensing frame includes weighting information N streams of sensing sequences of a second apparatus, and N is a positive integer; the third apparatus receives the N streams of weighted sensing sequences from the second apparatus; and the third apparatus processes the N streams of weighted sensing sequences based on the weighting information.

In this embodiment of this application, the method in the fourth aspect may be applied to an SR2SR sensing mode, and the first sensing frame may be an SR2SR sounding trigger frame in a sensing measurement process. The first apparatus serves as a sensing initiator (SI), and may be an access point (AP). The second apparatus and the third apparatus serve as sensing responders (SIs), and may be different non-access point stations (non-AP STATs). The second apparatus serves as a sensing transmitter (SR), and the third apparatus serves as a sensing receiver (SR).

In this solution of this application, the third apparatus serves as the sensing receiver. After receiving the N streams of weighted sensing sequences sent by the second apparatus, the third apparatus may accurately and effectively obtain, by solving based on the weighting information, of the N streams of sensing sequences of the second apparatus, indicated by the first sensing frame, information about corresponding transmission channels, and then can effectively perform a sensing task to obtain sensing information. The method can not only ensure that the third apparatus effectively performs the sensing task to obtain the sensing information, but also effectively avoid leakage of the sensing information.

In this embodiment of this application, in an implementation, the N streams of weighted sensing sequences of the second apparatus are obtained by separately performing weighting processing on the N streams of sensing sequences by using corresponding target weighting sequences. In another implementation, the N streams of weighted sensing sequences of the second apparatus are obtained by separately performing weighting processing on sensing symbols in the N streams of sensing sequences by using corresponding phase rotation values.

In a possible implementation, the weighting information includes N groups of bits, each group of bits indicates information about a target weighting sequence used by one stream of sensing sequence in the N streams, and the target weighting sequence corresponds to one row of the weighting matrix.

In a possible implementation, the weighting information includes M groups of bits, each group of bits indicates a phase rotation value of a sensing symbol in one stream of sensing sequence in the N streams, and M is a positive integer greater than 1.

In a possible implementation, the sensing symbol is weighted by using an 8 phase shift keying 8PSK modulation scheme.

In a possible implementation, the first sensing frame further includes first information, and the first information indicates one or more of the following: the quantity N of streams of the sensing sequences transmitted by the second apparatus, and identifier information corresponding to the N streams.

According to a fifth aspect, an embodiment of this application further provides a communication apparatus. The apparatus may be configured to perform the method in the first aspect. The apparatus may be a first apparatus, or the apparatus may be a component (for example, a chip, a chip system, or a circuit) in the first apparatus, or may be an apparatus that can be used in matching with the first apparatus.

In a possible implementation, the apparatus may include modules or units that one to one correspond to the method/operations/steps/actions described in the first aspect. The modules or units may be hardware circuits, software, or may be implemented by the hardware circuit in combination with software. In a possible implementation, the apparatus may include a processing unit (which may also be referred to as a processing module) and a communication unit (which may also be referred to as a communication module). The communication unit may be configured to perform a receiving and/or sending function, and the processing unit may be configured to perform the method in the first aspect or any possible implementation of the first aspect, or may be configured to perform the method in the second aspect or any possible implementation of the second aspect.

According to a sixth aspect, an embodiment of this application further provides a communication apparatus. The apparatus may be configured to perform the method in the third aspect. The apparatus may be a second apparatus, or the apparatus may be a component (for example, a chip, a chip system, or a circuit) in the second apparatus, or may be an apparatus that can be used in matching with the second apparatus.

In a possible implementation, the apparatus may include modules or units that one to one correspond to the method/operations/steps/actions described in the third aspect. The modules or units may be hardware circuits, software, or may be implemented by the hardware circuit in combination with software. In a possible implementation, the apparatus may include a processing unit (which may also be referred to as a processing module) and a communication unit (which may also be referred to as a communication module). The communication unit may be configured to perform a receiving and/or sending function, and the processing unit may be configured to perform the method in the third aspect or any possible implementation of the third aspect.

According to a seventh aspect, an embodiment of this application further provides a communication apparatus. The apparatus may be configured to perform the method in the fourth aspect. The apparatus may be a third apparatus, or the apparatus may be a component (for example, a chip, a chip system, or a circuit) in the third apparatus, or may be an apparatus that can be used in matching with the third apparatus.

In a possible implementation, the apparatus may include modules or units that one to one correspond to the method/operations/steps/actions described in the fourth aspect. The modules or units may be hardware circuits, software, or may be implemented by the hardware circuit in combination with software. In a possible implementation, the apparatus may include a processing unit (which may also be referred to as a processing module) and a communication unit (which may also be referred to as a communication module). The communication unit may be configured to perform a receiving and/or sending function, and the processing unit may be configured to perform the method in the fourth aspect or any possible implementation of the fourth aspect.

According to an eighth aspect, an embodiment of this application provides an apparatus. The apparatus includes at least one processor and a communication interface. The communication interface is configured to communicate with another apparatus. The processor is configured to run a group of programs, to enable the apparatus to implement the method provided in the first aspect or any possible implementation of the first aspect, or enable the apparatus to implement the method provided in the second aspect.

According to a ninth aspect, an embodiment of this application provides an apparatus. The apparatus includes at least one processor and a communication interface. The communication interface is configured to communicate with another apparatus. The processor is configured to run a group of programs, to enable the apparatus to implement the method provided in the third aspect or any possible implementation of the third aspect.

According to a tenth aspect, an embodiment of this application provides an apparatus. The apparatus includes at least one processor and a communication interface. The communication interface is configured to communicate with another apparatus. The processor is configured to run a group of programs, to enable the apparatus to implement the method provided in the fourth aspect or any possible implementation of the fourth aspect.

According to an eleventh aspect, an embodiment of this application further provides a computer storage medium. The storage medium stores a software program. When the software program is read and executed by one or more processors, the method provided in the first aspect or any possible implementation of the first aspect, the method provided in the second aspect or any possible implementation of the second aspect, the method provided in the third aspect or any possible implementation of the third aspect, or the method provided in the fourth aspect or any possible implementation of the fourth aspect can be implemented.

According to a twelfth aspect, an embodiment of this application further provides a computer program product including instructions. When the computer program product runs on a computer, the method provided in the first aspect or any possible implementation of the first aspect, the method provided in the second aspect or any possible implementation of the second aspect, the method provided in the third aspect or any possible implementation of the third aspect, or the method provided in the fourth aspect or any possible implementation of the fourth aspect is enabled to be performed.

According to a thirteenth aspect, an embodiment of this application further provides a communication system, including a first apparatus configured to perform the first aspect or the second aspect or any possible implementation of the first aspect or the second aspect, and a second apparatus configured to perform the third aspect or any possible implementation of the third aspect.

In a possible design, the communication system may further include a third apparatus configured to perform the fourth aspect or any possible implementation of the fourth aspect.

According to a fourteenth aspect, an embodiment of this application further provides a chip system. The chip system includes a processor, configured to support a first apparatus in implementing the functions in the first aspect or the second aspect, or configured to support a second apparatus in implementing the functions in the third aspect, or configured to support a third apparatus in implementing the functions in the fourth aspect.

In a possible design, the chip system further includes a memory. The memory is configured to store program instructions and data that are necessary for execution of a loading apparatus. The chip system may include a chip, or may include the chip and another discrete component.

It should be noted that, for technical effect that can be achieved in the fifth aspect to the fourteenth aspect or any possible implementation of the fifth aspect to the fourteenth aspect, refer to technical effect that can be achieved in the first aspect to the fourth aspect or any possible implementation of the first aspect to the fourth aspect. Details are not described herein again.

### BRIEF DESCRIPTION OF DRAWINGS

FIG. 1A is a diagram of a sensing measurement setup procedure and a sensing measurement procedure;

FIG. 1B is a diagram of transmission in a sensing measurement procedure;

FIG. 2 is a diagram of a structure of a pilot frame sent during sensing measurement;

FIG. 3 is a diagram of a design of weighting matrix values according to an embodiment of this application;

FIG. 4 is a diagram of a network architecture to which a communication method can be applied according to an embodiment of this application;

FIG. 5 is a schematic flowchart of a communication method according to an embodiment of this application;

FIG. 6 is a flowchart of a method in Embodiment 1 according to an embodiment of this application;

FIG. 7A is a diagram of a structure of a protected sensing measurement setup request frame according to an embodiment of this application;

FIG. 7B is a diagram of a structure of a protected sensing measurement setup response frame according to an embodiment of this application;

FIG. 8A is a diagram of a structure of a variable-length sensing subelements field according to an embodiment of this application;

FIG. 8B is a diagram of conversion of weighting matrices indicated by bit sequences of subelements according to an embodiment of this application;

FIG. 9A is a diagram of a structure of a sensing poll trigger frame according to an embodiment of this application;

FIG. 9B is a diagram of a structure of an SR2SI sounding trigger frame to a STA 1 according to an embodiment of this application;

FIG. 10 is a flowchart of a method in Embodiment 2 according to an embodiment of this application;

FIG. 11A is a diagram of a structure of another variable-length sensing subelements field according to an embodiment of this application;

FIG. 11B shows sensing symbols weighted through 8PSK modulation according to an embodiment of this application;

FIG. 12A is a diagram of indications of an SR2SR sounding trigger frame according to an embodiment of this application;

FIG. 12B is a diagram of indicating weight values by two SR2SR sounding trigger frames according to an embodiment of this application;

FIG. 13 is a diagram of a receiver user info field for an SR2SR sounding trigger frame according to an embodiment of this application;

FIG. 14 is a diagram of a structure of a communication apparatus according to an embodiment of this application;

FIG. 15 is a diagram of a structure of another communication device according to an embodiment of this application; and

FIG. 16 is a diagram of a structure of a chip according to an embodiment of this application.

### DESCRIPTION OF EMBODIMENTS

The following describes in detail embodiments of this application with reference to accompanying drawings of the specification.

Embodiments of this application may be applicable to a WLAN scenario, for example, may be applicable to Institute of Electrical and Electronics Engineers (Institute of Electrical and Electronics Engineers, IEEE) 802.11 series standards, for example, the 802.11ax standard, or a next generation thereof, for example, the 802.11be standard, Wi-Fi 7 or extremely high throughput (extremely high throughput, EHT), 802.11ad, 802.11ay, or 802.11 bf. Alternatively, embodiments of this application may further be applicable to a wireless local area network system like an internet of things (internet of things, IoT) network or a vehicle-to-everything (Vehicle to X, V2X) network. Certainly, embodiments of this application may alternatively be applicable to other possible communication systems, for example, a new radio (new radio, NR) system, a long term evolution (long term evolution, LTE) system, and a future communication system (for example, 6G communication system).

The following uses an 802.11 bf scenario as an example for description in embodiments of this application. Embodiments of this application relate to a sensing technology. The following describes related content of the sensing technology.

Sensing measurement may also be referred to as wireless sensing or WLAN sensing, and means that a transmitter and a receiver perform signal transmission to discover a target or determine a target status. For example, environment information (which may be referred to as sensing information) is sensed by using a wireless signal. The environment information includes distribution, sizes, a quantity, and temperatures of objects, human actions and behaviors, and even human breathing frequencies and heart rates in an environment. After the environment is sensed, subsequent processing may be performed with reference to various other technologies, such as AI, to reconstruct a physical environment, analyze the environment, identify and analyze persons and objects in the environment, and trigger subsequent actions.

WLAN sensing means that a station (station, STA) having a WLAN sensing capability detects, by using a received WLAN signal, feature information of an expected target in a given environment. For example, the feature information includes one or more of a distance, a speed, an angle, a motion, existence or proximity, a gesture, and the like. The target includes one or more of an object, a person, an animal, and the like. The environment includes one or more of a room, a house, a vehicle, an enterprise, and the like.

For example, a transmitter may send a signal for sensing measurement to a receiver, and the receiver may measure the signal to obtain a channel estimation result, for example, CSI. The receiver may perform sensing based on the CSI. Alternatively, the receiver may send the channel estimation result to the transmitter, and the transmitter performs target sensing or target status sensing based on the channel estimation result. For example, the receiver or the transmitter may process the CSI, to determine whether a moving object exists in an environment.

In a sensing measurement process, devices that participate in sensing are mainly as follows.

Sensing initiator (sensing initiator): A sensing initiator is a device that initiates a sensing measurement procedure and sends a sensing measurement setup request. For a non-DMG device, the sensing initiator is a device that sends a sensing measurement setup request frame. For a DMG device, the sensing initiator is a device that sends a DMG sensing measurement setup request frame.

Sensing responder (sensing responder): A sensing responder is a device that responds to a sensing procedure initiated by a sensing initiator and sends a sensing measurement response. For a non-DMG device, the sensing responder is a device that sends a sensing measurement setup response frame. For a DMG device, the sensing responder is a device that sends a DMG sensing measurement setup response frame.

Sensing transmitter (sensing transmitter): A sensing transmitter is a device that sends a sensing signal. The sensing signal may be a signal for sensing measurement, for example, a physical layer protocol data unit (physical layer protocol data unit, PPDU). Sensing may be WLAN sensing, or may be DMG sensing.

Sensing receiver (sensing receiver): A sensing receiver is a device that receives a sensing signal sent by a sensing transmitter. Sensing may be WLAN sensing, or may be DMG sensing.

In embodiments of this application, sensing may be WLAN sensing (for example, low-frequency sensing in sub 7 GHz) or (E) DMG sensing (namely, high-frequency sensing, for example, 60 GHz). DMG herein may represent high-frequency sensing, and a specific protocol used is not limited in this application. In embodiments of this application, low-frequency sensing in sub 7 GHz is used as an example for description.

Currently, WLAN sensing may include the following processes: sensing measurement setup, a sensing measurement instance, and sensing measurement disabling/termination.

After the sensing initiator completes sensing measurement setup, the sensing initiator initiates one or more sensing measurement instances (sensing measurement instances). The sensing measurement instance may be classified into a trigger-based (trigger-based, TB) sensing measurement instance and a non-trigger-based (non-trigger-based, Non-TB) sensing measurement instance. The TB sensing measurement instance is generally initiated by an AP, and the non-TB sensing measurement instance is generally initiated by a STA.

In an example of the TB sensing measurement instance, at least one of a polling phase (polling phase), a trigger frame (trigger frame, TF) sounding phase (sounding phase), a null data packet (packet) announcement (null data packet announcement, NDPA) sounding phase (sounding phase), and a reporting phase (reporting phase) may be included.

For the trigger frame (trigger frame, TF) sounding phase (sounding phase), one or more SRs may send pilot information to an SI to implement sensing, or one SR sends pilot information to the SR to implement sensing.

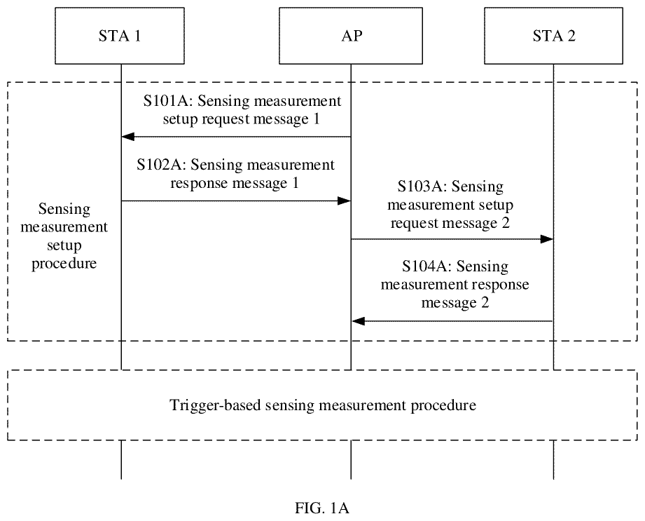

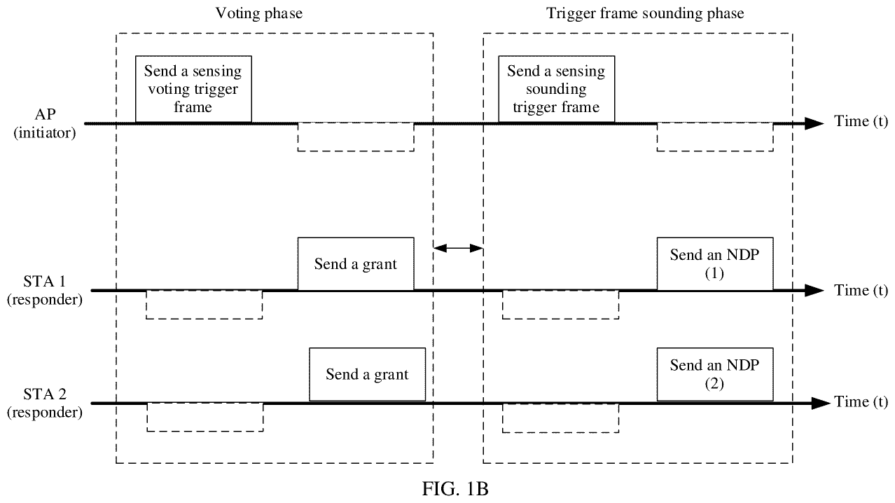

Refer to FIG. 1A. Before a sensing measurement procedure (trigger-based sensing measurement procedure) is performed, a sensing measurement setup procedure is first performed between an access point AP and sensing stations STAs (for example, a STA 1 and a STA 2 shown in FIG. 1A), and may include the following steps. S101A: The AP serves as a sensing initiator (SI), and sends a sensing measurement setup request message 1 to the STA 1, to request to set up sensing measurement. S102A: The STA 1 serves as a sensing responder (SR), and returns a sensing measurement setup response message 1 to the AP, to feed back whether to accept setup of sensing measurement. S103A: The AP may further send a sensing measurement setup request message 2 to the STA 2, to request to setup sensing measurement. S104A: The STA 2 also serves as a sensing responder (SI) and returns a sensing measurement setup response message 2 to the AP, to feed back whether to accept setup of sensing measurement. In the sensing measurement setup procedure, the AP and the STAs may configure and negotiate related information. As shown in FIG. 1B, in the trigger-based sensing measurement process, the AP serves as the sensing initiator (SI), and the STA 1 and the STA 2 serve as the sensing responders (SRs). In a voting phase, the AP sends a sensing voting trigger frame, and correspondingly, each STA receives the sensing voting trigger frame; and after that, the STA 1 and the STA 2 further send grants to the AP. Further, in a trigger frame sounding phase, the AP sends a sensing sounding trigger frame to the STA 1 and the STA 2; and after receiving the sensing sounding trigger frame, the STA 1 and the STA 2 may simultaneously send a plurality of pilot frames to the AP by using an uplink MIMO multi-stream (multi-stream) transmission method, to perform sensing. The pilot frame above may be referred to as a ranging null data packet (ranging null data packet, Ranging NDP), and may be referred to as an NDP for short below.

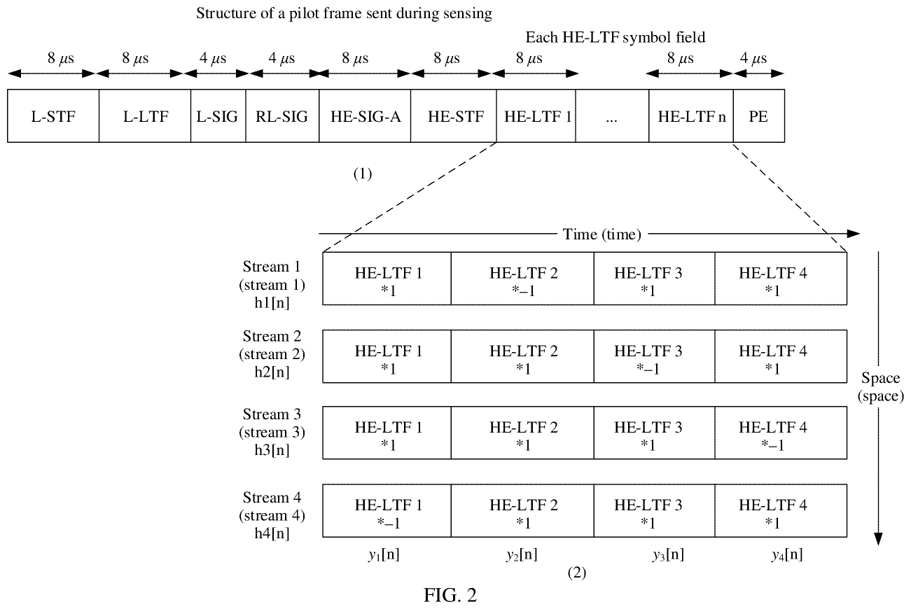

(1) in FIG. 2 shows a structure of a pilot frame (namely, a physical frame of an NDP) sent during sensing measurement. The structure of the physical frame of the NDP includes a high efficiency long training (HE-LTF) field, and the high efficiency long training field (HE-LTF) includes one or more consecutive HE-LTF symbols. If a transmitter sends the pilot frame simultaneously in multiple streams, that is, sends the NDP simultaneously in multiple streams, the NDP in each stream passes through a different channel. As shown in (2) in FIG. 2, for example, the NDP is sent simultaneously in four streams, and the four streams are respectively referred to as a stream 1 (Stream 1) to a stream 4 (Stream 4). An HE-LTF field corresponding to each stream includes four consecutive HE-LTF symbols in time (namely, an HE-LTF 1, an HE-LTF 2, an HE-LTF 3, and an HE-LTF 4), and channels through which the four streams pass respectively correspond to h1 to h4. When MIMO multi-stream transmission is used, the four HE-LTF symbols (namely, the HE-LTF 1, the HE-LTF 2, the HE-LTF 3, and the HE-LTF 4) in the four streams undergo different weighting, that is, multiplied by +1 or multiplied by −1 on the original HE-LTF symbols. As shown in (2) in FIG. 2, a weighting matrix is also determined accordingly when a quantity of transmitted streams is determined. For example, when transmission is performed in four streams, the weighting matrix used in a current protocol is specified as the following matrix:

$${P}_{HT - LTF} = [ \begin{matrix}1 & - 1 & 1 & 1 \\ 1 & 1 & - 1 & 1 \\ 1 & 1 & 1 & - 1 \\ - 1 & 1 & 1 & 1\end{matrix} ]$$

Then, channel information corresponding to transmission of the four streams can be obtained, that is, can be respectively represented as the following formulas:

$${\hat{h}}_{1} [ n ] = ( {y}_{1} [ n ] - {y}_{2} [ n ] + {y}_{3} [ n ] + {y}_{4} [ n ] ) / 4$$

$${\hat{h}}_{2} [ n ] = ( {y}_{1} [ n ] + {y}_{2} [ n ] - {y}_{3} [ n ] + {y}_{4} [ n ] ) / 4$$

$${\hat{h}}_{3} [ n ] = ( {y}_{1} [ n ] + {y}_{2} [ n ] + {y}_{3} [ n ] - {y}_{4} [ n ] ) / 4$$

$${\hat{h}}_{4} [ n ] = ( - {y}_{1} [ n ] + {y}_{2} [ n ] + {y}_{3} [ n ] + {y}_{4} [ n ] ) / 4$$

Herein, y₁[n] to y₄[n]) correspondingly represent the four HE-LTF symbols in an NDP sequence, and ĥ₁[n] to ĥ₁[n] represent the channel information corresponding to transmission of the four streams.

However, in an existing TB sensing solution, only a public pilot can be for channel estimation to perform a sensing task. That is, all transmitted pilot frames NDPs are public. Therefore, when sensing is performed between an AP and a STA, sent pilot information may be passively received by a third-party listener to learn of sensing content (or sensing information). For example, a third party may perform channel estimation on a received signal, and user privacy information (for example, personal physical data, heartbeats, and breathing of a user) may be exposed to the third party due to sensing.

To resolve the foregoing problem, a current solution (the 802.11az standard) provides a secure HE-LTF transmission solution. That is, high-order modulation (64QAM modulation) is performed on a sent pilot, and the pilot is encrypted (AES) by using a cryptography method. However, the solution is to protect integrity of the sent ranging pilot (Ranging NDP), but cannot effectively protect sensing privacy. In addition, because high-order modulation information is used in the pilot, sensing performance is affected, and sensing precision is reduced or sensing information cannot be obtained.

Therefore, this application provides a communication method, to effectively resolve leakage of sensing information in sensing measurement, and effectively avoid leakage of user privacy information. An application scenario of embodiments of this application may be but is not limited to: In a WLAN communication system, when an AP initiates sensing and sensing responders STAs send null data packets as sensing pilots for sensing, the plurality of STAs jointly send the sensing pilots for sensing.

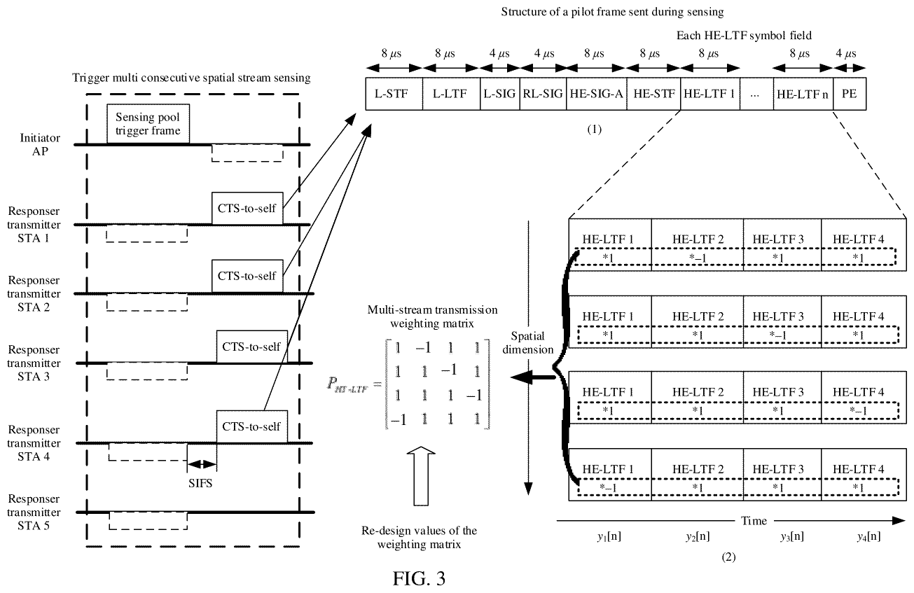

From the perspective of an operating frequency of Wi-Fi, the application scenario of embodiments of this application may be low-frequency Wi-Fi (in sub 7 G) and high-frequency Wi-Fi (at millimeter wave band). From the perspective of a Wi-Fi standard, embodiments of this application may support Wi-Fi 6, Wi-Fi 7 (EHT), and Wi-Fi 8 (UHR) scenarios. For example, (1) in FIG. 3 is a diagram of a structure of a pilot frame sent during sensing. In embodiments of this application, when multi-spatial-stream sensing data (namely, the pilot frame) is sent, a weighting matrix used to weight multiple spatial streams is designed, as shown in (2) in FIG. 3. Different weighting matrices are designed to implement different sensing transmit pilots (namely, sensing transmit symbols, where the pilots include multiple symbols), to implement privacy protection.

The following explains and describes the communication method provided in embodiments of this application with reference to the accompanying drawings.

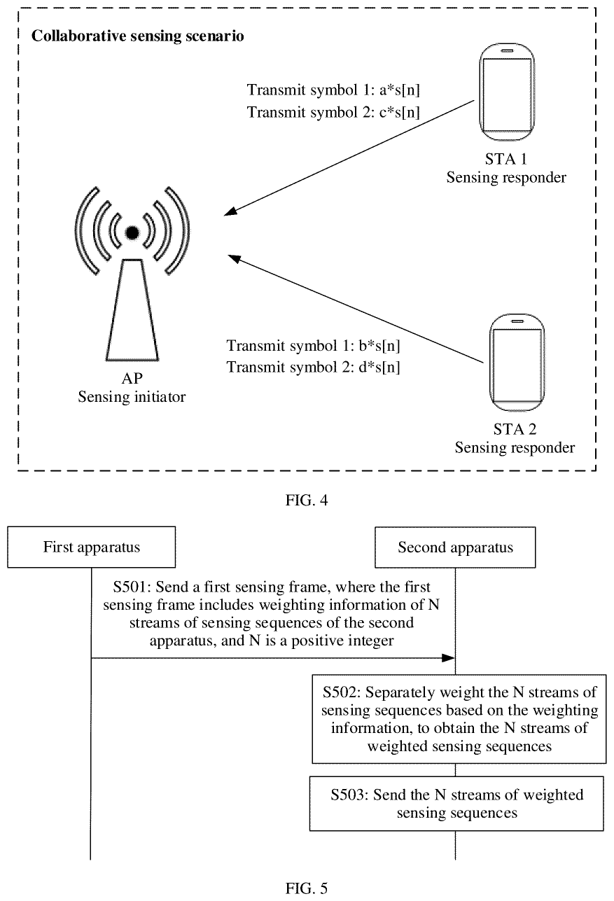

FIG. 4 is a diagram of an example of a system architecture of a WLAN to which an embodiment of this application is applicable. In FIG. 4, for example, the WLAN includes one access point (access point, AP) and two stations (stations, STAs) (that is, in a collaborative sensing scenario). The AP serves as a sensing initiator (or an initiator). The STA 1 and the STA 2 serve as sensing responders (or responders), and each may collaboratively send two consecutive sensing symbols 1 and 2 to the AP. In this embodiment of this application, element values of a used sensing matrix may be designed, to implement privacy protection. In addition, embodiments of this application are also applicable to communication between APs. For example, the APs may communicate with each other through a distributed system (distributed system, DS). Embodiments of this application are also applicable to communication between STAs. It should be understood that quantities of APs and STAs in FIG. 4 are merely an example. There may be more or less APs and STAs.

A STA associated with an AP may be briefly referred to as an associated STA, and the STA may establish an association with the AP by using an association procedure. A STA that does not establish an association with an AP may be briefly referred to as a non-associated STA.

The access point may be an access point through which a terminal device (for example, a mobile phone) accesses a wired (or wireless) network, and is mainly deployed at home, in a building, and in a campus, with a typical coverage radius ranging from tens of meters to 100-odd meters. Certainly, the access point may alternatively be deployed outdoors. The access point is equivalent to a bridge that connects a wired network and a wireless network, and is mainly used to connect various wireless network clients together and then connect the wireless network to an ethernet. Specifically, the access point may be a terminal device (for example, a mobile phone) or a network device (for example, a router) with a Wi-Fi chip. The access point may be a device that supports the 802.11be standard. Alternatively, the access point may be a device that supports a plurality of wireless local area network (wireless local area network, WLAN) standards of the 802.11 family such as 802.11ay, 802.11ad, 802.11ax, 802.11ac, 802.11n, 802.11g, 802.11b, 802.11a, and a next-generation standard of 802.11be. The access point in this application may be an HE AP, an extremely high throughput (extremely high throughput, EHT) AP, or an access point applicable to a future-generation Wi-Fi standard.

The station may be a wireless communication chip, a wireless sensor, a wireless communication terminal, or the like, and may also be referred to as a user. For example, the station may be a mobile phone, a tablet computer, a set-top box, a smart television, a smart wearable device, a vehicle-mounted communication device, or a computer that supports a Wi-Fi communication function, and the like. Optionally, the station may support the 802.11be standard. Alternatively, the station may support a plurality of wireless local area network (wireless local area network, WLAN) standards of the 802.11 family such as 802.11ay, 802.11ad, 802.11ax, 802.11ac, 802.11n, 802.11g, 802.11b, 802.11a, and a next-generation standard of 802.11be.

The station in this application may be a directional multi-gigabit (directional multi-gigabit, DMG) STA, an enhanced directional multi-gigabit EDMG (enhanced directional multi-gigabit, EDMG) STA, an HE STA, or an extremely high throughput (extremely high throughput, EHT) STA, or may be a STA applicable to a future-generation Wi-Fi standard.

For example, the access point and the station may be devices used in an internet of vehicles, internet of things nodes or sensors in an internet of things (IoT, internet of things), smart cameras, smart remote controls, or smart water or electricity meters in a smart home, or sensors in a smart city.

The AP and the STA in embodiments of this application may be an AP and a STA that are applicable to the IEEE 802.11 series standards. The AP is an apparatus that is deployed in a wireless communication network and that provides a wireless communication function for a STA associated with the AP. The AP may be used as a center of a communication system, and is usually a network-side product that supports MAC and PHY in the 802.11 series standards, for example, may be a communication device like a base station, a router, a gateway, a repeater, a communication server, a switch, or a bridge. The base station may include a macro base station, a micro base station, a relay station, or the like in various forms. Herein, for ease of description, the devices mentioned above are collectively referred to as an AP. The STA is usually a terminal product that supports media access control (media access control, MAC) and a physical (physical, PHY) layer in the 802.11 series standards, for example, a mobile phone or a notebook computer.

FIG. 5 is a schematic flowchart of a communication method according to an embodiment of this application. A method procedure provided in this embodiment of this application may be applied to but is not limited to the system architecture shown in FIG. 4. The AP or a chip in the AP in FIG. 4 may perform the method performed by a first apparatus in the following procedure, the STA (for example, the STA 1) or a chip in the STA (for example, the STA 1) in FIG. 4 may perform the method performed by a second apparatus in the following procedure, and the STA (for example, the STA 2) or a chip in the STA (for example, the STA 2) in FIG. 4 may perform the method performed by a third apparatus in the following procedure. It may be understood that a specific structure of an entity for executing the method provided in this embodiment of this application is not specifically limited in the following embodiments, provided that a program that records code for the method provided in this embodiment of this application can be run to perform communication according to the method provided in this embodiment of this application. With reference to FIG. 5, a specific procedure of the method is as follows.

S501: The first apparatus sends a first sensing frame to the second apparatus, where the first sensing frame includes weighting information N streams of sensing sequences of the second apparatus, and N is a positive integer. Correspondingly, the second apparatus receives the first sensing frame.

In this embodiment of this application, the first apparatus may be an access point (AP), and the second apparatus may be a non-access point station (non-AP STAT).

In this embodiment of this application, one stream of sensing sequence may be considered as a sensing data stream (or a sensing stream), and each stream of sensing sequence may be transmitted through a corresponding channel. From a spatial dimension, each stream of sensing sequence may also be referred to as a sensing sequence of each spatial stream. For example, the sensing sequence may be a ranging pilot frame NDP, and a sensing symbol in the sensing sequence may be an HE-LTF symbol in the NDP. The first sensing frame may be a sensing sounding trigger frame in a sensing setup process. In addition, in this embodiment of this application, in a multi-stream transmission scenario, N is a positive integer greater than 1.

In this embodiment of this application, the first apparatus serves as a sensing initiator (SI for short), and the second apparatus serves as a sensing responder (SR for short). Before the first apparatus sends the first sensing frame to the second apparatus, the first apparatus and the second apparatus further perform a sensing measurement setup process.

For the sensing measurement setup process, embodiments of this application may include but are not limited to the following two implementation solutions:

Implementation solution 1: The first apparatus sends a request message to the second apparatus, where the request message is used to request to set up sensing measurement, the request message includes at least one sensing subelement, and each sensing subelement corresponds to a weighting matrix.

In a possible implementation, the sensing subelement includes a weighting matrix indication field, and the weighting matrix indication field indicates the corresponding weighting matrix.

For example, the weighting matrix field may include X bits, where X is a positive integer. The X bits include three parts. A first part indicates a weighting matrix of 2×2, a second part indicates a weighting matrix of 4×4, and the second part and a third part jointly indicate a weighting matrix of 8×8.

In this embodiment of this application, a weighting matrix of a×b may be a matrix with a rows and b columns for weighting. A quantity of rows (namely, a value of a) of the weighting matrix may correspond to a quantity of sent sensing sequences of streams, and a quantity of columns (namely, a value of b) of the weighting matrix may correspond to a quantity of sensing symbols in one stream of sensing sequence. In a weighting process, one row (referred to as a weighting sequence in this embodiment of this application) in the weighting matrix corresponds to one stream of sensing sequence for weighting.

Implementation solution 2: The first apparatus sends a request message to the second apparatus, where the request message is used to request to set up sensing measurement, the request message includes at least one sensing subelement, and each sensing subelement corresponds to a phase rotation codebook of a sensing sequence.

In a possible implementation, the sensing subelement includes a codebook indication field, and the codebook indication field indicates the phase rotation codebook of the sensing sequence.

For example, the codebook indication field includes Y bits, where Y is a positive integer. The Y bits include L groups of bits, and each group of bits indicates coding of one phase rotation manner.

In the foregoing, coding of one phase rotation manner may correspond to but are not limited to one phase shift weight value or an index of the phase shift weight value. In this embodiment of this application, coding of the phase rotation manner may be considered as a weight value, a weighting value, a weight index, or the like for weighting a symbol.

In an implementation, in Implementation solution 1 and Implementation solution 2, the first request message further includes first indication information, and the first indication information indicates to use a weighted collaborative sensing mode. In this embodiment of this application, the first indication information may be located in a sensing measurement parameters element in the sensing measurement request frame.

Correspondingly, Implementation solution 1 and Implementation solution 2 further include: The second apparatus sends, to the first apparatus, a response message for requesting to set up sensing measurement, where the response message indicates that the second apparatus supports to use the weighted collaborative sensing mode. Correspondingly, the first apparatus receives the response message from the second apparatus.

In an implementation, before the first apparatus sends the first sensing frame to the second apparatus, the first apparatus determines the weighting information of the N streams of sensing sequences of the second apparatus.

In this embodiment of this application, based on the foregoing Implementation solution 1 and Implementation solution 2, correspondingly, the weighting information determined by the first apparatus may include the following two cases.

Case 1: The weighting information includes N groups of bits, each group of bits indicates information about a target weighting sequence used by one stream of sensing sequence in the N streams, and the target weighting sequence corresponds to one row of the weighting matrix.

Case 1 is based on the foregoing Implementation solution 1, and the first apparatus further determines the weighting information of the N stream sensing sequences of the second apparatus. In this embodiment of this application, the target weighting sequence may correspond to one row of the weighting matrix corresponding to the at least one sensing subelement in the request message.

Case 2: The weighting information includes M groups of bits, each group of bits indicates a phase rotation value of a sensing symbol in one stream of sensing sequence in the N streams, M is a positive integer greater than 1, and a value of M may be equal to a value of N.

In this embodiment of this application, the sensing symbol is weighted by using an 8 phase shift keying (8 phase shift keying, 8PSK) modulation scheme.

Case 2 is based on the foregoing Implementation solution 2, and the first apparatus further determines the weighting information of the N stream sensing sequences of the second apparatus. In a possible implementation, the phase rotation codebook corresponding to the at least one sensing subelement in the first request message includes the M groups of bits.

In an implementation, before the first apparatus sends the first sensing frame, the method further includes: The first apparatus sends a second sensing frame to the second apparatus, where the second sensing frame includes second indication information, and the second indication information indicates to weight and transmit the sensing sequences.

For example, the second sensing frame is a sensing voting trigger frame, and the second indication information is information about a reserved bit in the sensing voting trigger frame.

S502: The second apparatus separately weights the N streams of sensing sequences based on the weighting information, to obtain the N streams of weighted sensing sequences.

In this embodiment of this application, based on the two cases of the weighting information determined by the first apparatus, step S502 may include the following implementations.

In an implementation, based on Case 1 (that is, the weighting information includes the N groups of bits, each group of bits indicates the information about the target weighting sequence used by one stream of sensing sequence in the N streams, and the target weighting sequence corresponds to one row of the weighting matrix), that the second apparatus separately weights the N streams of sensing sequences based on the weighting information, to obtain the N streams of weighted sensing sequences may include: The second apparatus may determine, based on the N groups of bits in the weighting information, target weighting sequences used by the N streams of sensing sequences; and further, the second apparatus separately weights the N streams of sensing sequences by using the corresponding target weighting sequences, to obtain the N streams of weighted sensing sequences.

In another implementation, based on Case 2 (that is, the weighting information includes the M groups of bits, each group of bits indicates the phase rotation value of the sensing symbol in one stream of sensing sequence in the N streams, and M is a positive integer greater than 1), that the second apparatus separately weights the N streams of sensing sequences based on the weighting information, to obtain the N streams of weighted sensing sequences may include: The second apparatus may determine the phase rotation values of the sensing symbols in the N streams of sensing sequences based on the M groups of bits in the weighting information; and further, the second apparatus may weight the N streams of sensing sequences based on the phase rotation values of the sensing symbols in the N streams of sensing sequences, to obtain the N streams of weighted sensing sequences.

S503: The second apparatus sends the N streams of weighted sensing sequences.

In this embodiment of this application, the second apparatus serves as a transmitter (namely, a transmitter of a sensing signal, which is referred to as a sensing transmitter for short) of the sensing sequences. In this case, the second apparatus sends the N streams of weighted sensing sequences to a receiver (namely, a receiver of the sensing signal, which is referred to as a sensing receiver for short) of the sensing sequences.

In this embodiment of this application, when step S503 (that is, the second apparatus sends the N streams of weighted sensing sequences) is performed, the following several implementations may be included.

In an implementation, the second apparatus sends the N streams of weighted sensing sequences to the first apparatus. Correspondingly, the first apparatus receives the N streams of weighted sensing sequences from the second apparatus. Optionally, this implementation may be applied to an SR2SI sensing mode. The second apparatus is a sensing transmitter, and the first apparatus is a sensing receiver. In this case, the first sensing frame may be an SR2SI sounding trigger frame.

Further, the first apparatus may obtain, by solving based on the weighting information of the N streams of sensing sequences and the N streams of weighted sensing sequences, information about channels for transmitting the corresponding N streams.

In another implementation, the second apparatus sends the N streams of weighted sensing sequences to the third apparatus. Correspondingly, the third apparatus receives the N streams of weighted sensing sequences from the second apparatus. Optionally, this implementation may be applied to an SR2SR sensing mode. The second apparatus is a sensing transmitter, and the third apparatus is a sensing receiver. The first sensing frame may be an SR2SR sounding trigger frame.

For example, the third apparatus may be a non-access point station (non-AP STAT) different from the second apparatus.

In an implementation, before the third apparatus receives the N streams of weighted sensing sequence from the second apparatus, the method further includes: The third apparatus receives a first sensing frame from the first apparatus, where the first sensing frame includes weighting information of the N streams of sensing sequences of the second apparatus. Optionally, the first sensing frame further includes first information, and the first information may indicate but is not limited to one or two of a quantity N of streams for which the second apparatus transmits the sensing sequences and identifier information corresponding to the N streams.

Further, the third apparatus may obtain, by solving based on the weighting information of the N streams of sensing sequences of the second apparatus and the N streams of weighted sensing sequences of the second apparatus, information about channels for transmitting the corresponding N streams.

In a possible implementation, based on Case 1 (that is, the weighting information includes the N groups of bits, each group of bits indicates the information about the target weighting sequence used by one stream of sensing sequence in the N streams, and the target weighting sequence corresponds to one row of the weighting matrix), that the third apparatus obtains, based on the weighting information of the N streams of sensing sequences of the second apparatus and the N streams of weighted sensing sequences of the second apparatus, the information about the channels for transmitting the N streams of sensing sequences may include: The third apparatus may first determine, based on the N groups of bits in the weighting information, target weighting sequences used by the N streams of sensing sequences; and then, obtain, by solving based on the target weighting sequences used by the N streams of sensing sequences and the N streams of weighted sensing sequences of the second apparatus, the information about the channels for transmitting the N streams of sensing sequences. For example, for a specific manner of obtaining the information about the channel by solving, refer to the method in step S607a in Embodiment 1. Details are not described herein.

In another possible implementation, based on Case 2 (that is, the weighting information includes the M groups of bits, each group of bits indicates the phase rotation value of the sensing symbol in one stream of sensing sequence in the N streams, and M is a positive integer greater than 1), that the third apparatus may obtain, based on the weighting information of the N streams of sensing sequences of the second apparatus and the N streams of weighted sensing sequences of the second apparatus, the information about the channels for transmitting the N streams of sensing sequences may include: The third apparatus may determine phase rotation values of the sensing symbols in the N streams of sensing sequences based on the M groups of bits in the weighting information, and further, obtain, by solving based on the phase rotation values of the sensing symbols in the N streams of sensing sequences and the N streams of weighted sensing sequences, the information about the channels for transmitting the N streams of sensing sequences. For example, for a specific manner of obtaining the information about the channel by solving, refer to the method in step S1007a in Embodiment 2. Details are not described herein.

In conclusion, this embodiment of this application provides the communication method. The method includes: The first apparatus determines the weighting information of the N streams of sensing sequences of the second apparatus, where N is a positive integer; and the first apparatus sends the first sensing frame, where the first sensing frame includes the weighting information. After receiving the first sensing frame, the second apparatus may weight the N streams of sensing sequences of the second apparatus based on the weighting information, of the N streams of sensing sequences, in the first sensing frame, and then perform transmission. This can effectively avoid leakage of sensing information.

Based on the communication method shown in FIG. 5, the following further describes several specific embodiments in detail.

### Embodiment 1

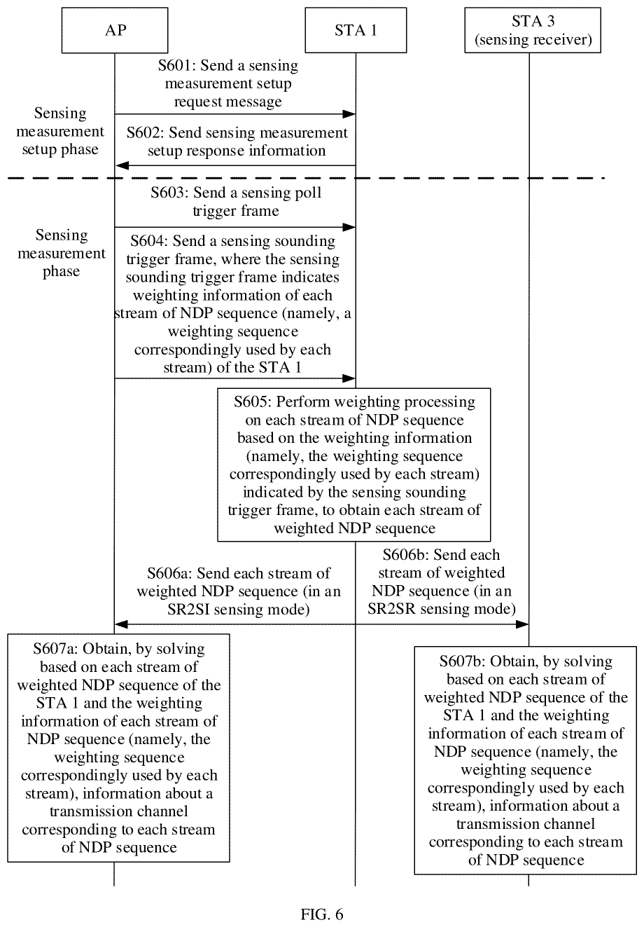

Embodiment 1 is mainly described based on Implementation solution 1 shown in FIG. 5. That is, in sensing measurement setup, the first apparatus may first send, to the second apparatus, the request message for requesting to set up sensing measurement, to indicate the second apparatus at least one weighting matrix; and further, the first apparatus may indicate, to the second apparatus based on the at least one weighting matrix, information about the target weighting sequences used by the N streams of sensing sequences of the second apparatus, where the target weighting sequence corresponds to one row of the weighting matrix, to implement weight and transmission of the N streams of sensing sequences. In Embodiment 1, the first apparatus is an AP as an example, the AP serves as a sensing initiator (SI), the second apparatus is a STA 1 (or a STA 2) as an example, the STA 1 (or the STA 2) serves as a sensing responder, and STAs may perform collaborative sensing and use a multi-stream transmission manner. As shown in FIG. 6, a procedure of Embodiment 1 is as follows.

S601: The AP sends a sensing measurement setup request message to the STA 1.

Correspondingly, the STA 1 receives the sensing measurement setup request message (which is equivalent to the first request message in the solution in FIG. 5).

In a possible implementation, the sensing measurement setup request message includes 1-bit signaling (which is equivalent to the first indication information in the solution in FIG. 5), and the 1-bit signaling indicates to use a weighted collaborative sensing mode.

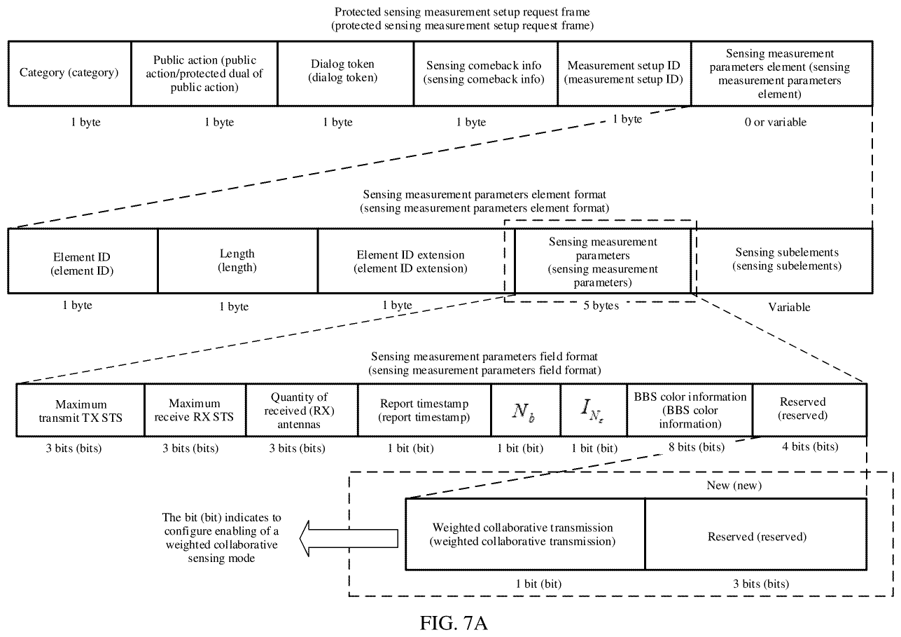

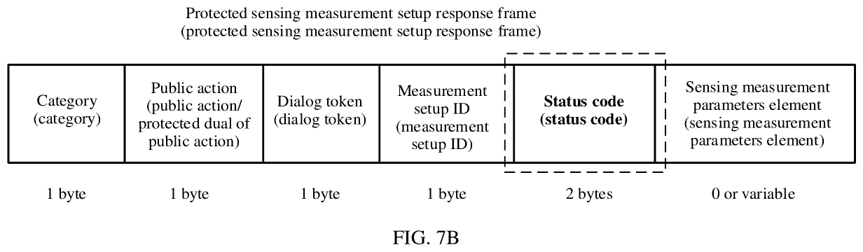

For example, FIG. 7A is a diagram of a structure of a protected sensing measurement setup request frame. The sensing measurement setup request frame includes a sensing measurement parameters element, and a sensing measurement parameters field format includes four reserved bits (bits). One (bit) of the four bits (bits) (which may be equivalent to the first indication information in the solution in FIG. 5) may indicate to use the weighted collaborative sensing mode.

In a possible implementation, the sensing measurement setup request message further includes a variable-length sensing subelements field, and the variable-length sensing subelements field indicates information about a weighting matrix.

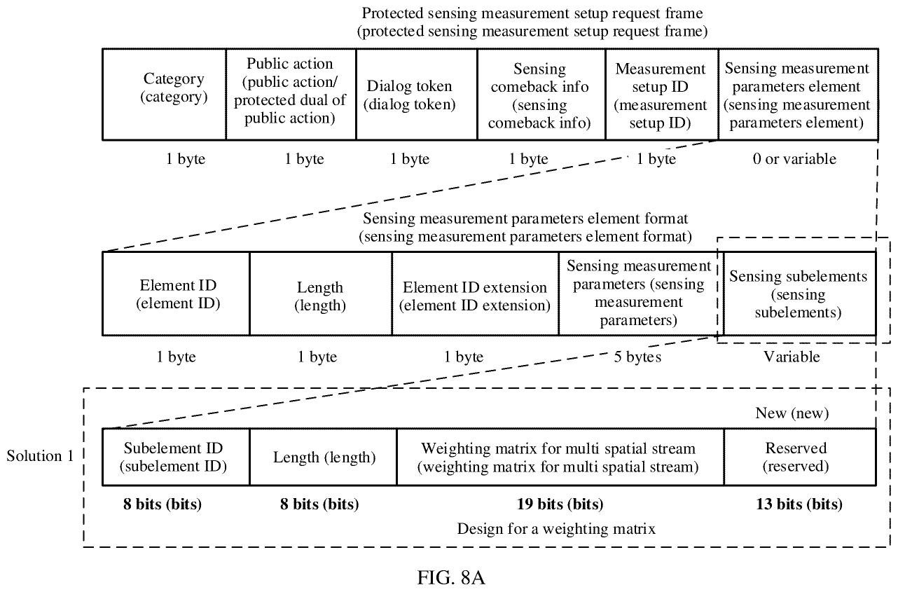

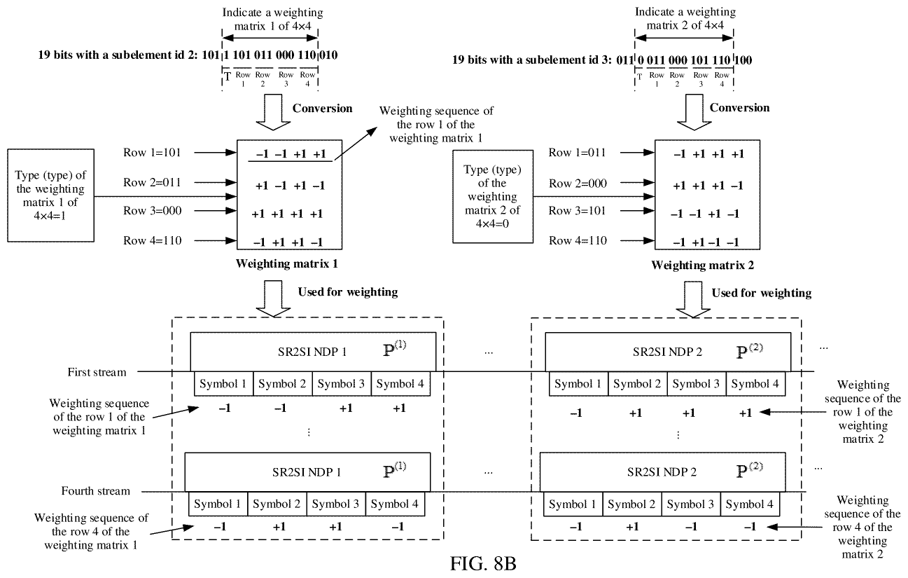

For example, as shown in FIG. 8A, the variable-length sensing subelements field includes six bytes (a total of 48 bits), where in the six bytes (the total of 48 bits), eight bits indicate a sensing subelement ID, and 19 bits are used to determine the specific weighting matrix.

More IDs may be added in the sensing subelement ID based on the conventional technology (that is, the sensing subelement ID is 0 or 1). As shown in Table 1, the sensing subelement ID may be 2 to x, where x is a positive integer. Sensing subelements with different IDs may indicate different weighting matrix configurations.

TABLE 1

| Sensing | | |
|---|---|---|
| subelement | | Extensible |
| (subelement) ID | Name (name) | (extensible) |
| 0 | Non-trigger-based sensing non-TB | Yes (yes) |
| | sensing xxx | |
| 1 | Trigger-based sensing TB sensing xxx | Yes (yes) |
| 2 to x | Weighting information (weighting | Yes (yes) |
| | information) | |
| (x + 1) to 255 | Reserved (reserved) | |

Table 1 is used as an example. Table 1 designed in practice may include more or less content.

For the 19 bits used to determine the specific weighting matrix, the 19 bits may be divided into three segments (three groups). For example, for a bit 0 to a bit 18, a first segment is the bit 0 to the bit 2, a second segment is the bit 3 to the bit 15, and a third segment is the bit 16 to the bit 18. The first segment (namely, the bit 0 to the bit 2) indicates a weighting matrix with two rows (namely, streams) and two columns (namely, symbols in an NDP), that is, a weighting matrix of 2×2, and the weighting matrix of 2×2 may be applicable to weighting in a scenario of one transmission stream and two transmission streams. The second segment (namely, the bit 3 to the bit 15) indicates a weighting matrix with four rows (namely, streams) and four columns (namely, symbols in an NDP), that is, a weighting matrix of 4×4, and the weighting matrix of 4×4 may be applicable to weighting in a scenario of three and four transmission streams. The second segment (namely, the bit 3 to the bit 15) and the third segment (namely, the bit 16 to the bit 18) jointly indicate a weighting matrix with eight rows (namely, streams) and eight columns (namely, symbols in an NDP), that is, a weighting matrix of 8×8, and the weighting matrix of 8×8 may be applicable to weighting in a scenario of five to eight transmission streams.

In Embodiment 1, the bits in each segment may indicate the corresponding weighting matrix in the following implementations.

The weighting matrix of 2×2 indicated by the first segment (namely, the bit 0 to the bit 2) is implemented in the following manner.

Table 2 is a mapping relationship table between three bits (the bit 0 to the bit 2, namely, three binary digits) and a weighting matrix (the weighting matrix of 2×2). The mapping relationship table may be predefined between the AP and the STA 1 and known to both the AP and the STA 1. The bit 0 indicates a category, and the bit 1 and the bit 2 indicate the corresponding weighting matrix of 2×2.

TABLE 2

Bit 1 and bit 2

| Bit 0 | 00 | 01 | 10 | 11 |
|---|---|---|---|---|
| 0 | +1 +1 | +1 +1 | +1 −1 | −1 +1 |
| | +1 −1 | −1 +1 | +1 +1 | +1 +1 |
| 1 | −1 −1 | −1 −1 | −1 +1 | +1 −1 |
| | −1 +1 | +1 −1 | −1 −1 | −1 −1 |

To be specific, when the bit 0, the bit 1, and the bit 2 are 000, the corresponding weighting matrix is

$$[ \begin{matrix}+ 1 & + 1 \\ + 1 & - 1\end{matrix} ] ;$$

when the bit 0, the bit 1, and the bit 2 are 001, the corresponding weighting matrix is

$$[ \begin{matrix}+ 1 & + 1 \\ - 1 & + 1\end{matrix} ] ;$$

when the bit 0, the bit 1, and the bit 2 are 010, the corresponding weighting matrix is

$$[ \begin{matrix}+ 1 & - 1 \\ + 1 & + 1\end{matrix} ] ;$$

when the bit 0, the bit 1, and the bit 2 are 011, the corresponding weighting matrix is

$$[ \begin{matrix}- 1 & + 1 \\ + 1 & + 1\end{matrix} ] ;$$

when the bit 0, the bit 1, and the bit 2 are 100, the corresponding weighting matrix is

$$[ \begin{matrix}- 1 & - 1 \\ - 1 & + 1\end{matrix} ] ;$$

when the bit 0, the bit 1, and the bit 2 are 101, the corresponding weighting matrix is

$$[ \begin{matrix}- 1 & - 1 \\ + 1 & - 1\end{matrix} ] ;$$

when the bit 0, the bit 1, and the bit 2 are 110, the corresponding weighting matrix is

$$[ \begin{matrix}- 1 & + 1 \\ - 1 & - 1\end{matrix} ] ;$$

when the bit 0, the bit 1, and the bit 2 are 111, the corresponding weighting matrix is

$$[ \begin{matrix}+ 1 & - 1 \\ - 1 & - 1\end{matrix} ] .$$

For example, if the weighting matrix of 2×2 indicated to the STA 1 is

$$[ \begin{matrix}- 1 & - 1 \\ - 1 & + 1\end{matrix} ] ,$$

the AP queries Table 2 to determine that the corresponding bit 0 to bit 2 may be 100, and the AP may configure the first segment (the bit 0 to the bit 2) of the 19 bits included in the sensing subelements field as 100.

In another possible implementation of this application, the bit 0 may not be required.

The weighting matrix of 4×4 indicated by the second segment (namely, the bit 3 to the bit 15) is implemented in the following manner.

Table 3A is a mapping relationship table between 13 bits (the bit 3 to the bit 15, namely, 13 binary digits) and a weighting matrix (the weighting matrix of 4×4). The mapping relationship table 3A may be predefined between the AP and the STA 1 and known to both the AP and the STA 1. The bit 3 indicates a category, and the bit 4 to the bit 15 indicate the corresponding weighting matrix of 4×4. In the bit 4 to the bit 15, every three consecutive bits form a group, and each group is used to determine one row of a weighting sequence corresponding to one stream. For example, the bit 4 to the bit 6 form a group (which may correspond to a first stream), the bit 7 to the bit 9 form a group (which may correspond to a second stream), the bit 10 to the bit 12 form a group (which may correspond to a third stream), and the bit 13 to the bit 15 form a group (which may correspond to a fourth stream). In this embodiment of this application, a value of a group of the bit 5 and the bit 6 may be any one of 00, 01, 10, and 11. Similarly, a value of any group of the bit 8 and the bit 9/the bit 11 and the bit 12/the bit 14 and the bit 15 may also be any one of 00, 01, 10, and 11. A second bit and a third bit (the bit 5 and the bit 6/the bit 8 and the bit 9/the bit 11 and the bit 12/the bit 14 and the bit 15) in each group are used to determine one row of a corresponding weighting sequence. A first bit in each group is used to determine positive and negative changes of the row of the corresponding weighting sequence. For example, when the first bit (the bit 4/the bit 7/the bit 10/the bit 13) in each group is 0, the row of the corresponding weighting sequence is multiplied by +1. When the first bit (the bit 4/the bit 7/the bit 10/the bit 13) in each group is 1, the row of the corresponding weighting sequence is multiplied by −1. In another possible implementation of this application, the bit 4/the bit 7/the bit 10/the bit 13 may not be required. In another possible implementation of this application, the bit 3 may not be required.

TABLE 3A

| | Bit 4/Bit 7/Bit | | Bit 5 and bit 6/Bit 8 and bit 9/ | | | |
|---|---|---|---|---|---|---|
| | 10/Bit 13 | | Bit 11 and bit 12/Bit 14 and bit 15 | | | |
| Bit 3 | 0 | 1 | 00 | 01 | 10 | 11 |
| 0 | x + 1 | x − 1 | +1 +1 +1 −1 | +1 +1 −1 +1 | +1 −1 +1 +1 | −1 +1 +1 +1 |
| 1 | | | +1 +1 +1 +1 | +1 +1 −1 −1 | +1 −1 −1 +1 | +1 −1 +1 −1 |

TABLE 3B

| | Bit 4/Bit 7/Bit | | Bit 5 and bit 6/Bit 8 and bit 9/ | | | |
|---|---|---|---|---|---|---|
| | 10/Bit 13 | | Bit 11 and bit 12/Bit 14 and bit 15 | | | |
| Bit 3 | 0 | 1 | 00 | 01 | 10 | 11 |
| 0 | x + 1 | x − 1 | +1 +1 +1 −1 | +1 +1 −1 +1 | +1 −1 +1 +1 | −1 +1 +1 +1 |
| 1 | | | +1 +1 +1 +1 | +1 +1 −1 −1 | +1 −1 −1 +1 | +1 −1 +1 −1 |
| Weighting | 0 (+1) | 1 (−1) | Row 3 = 000 | Row 1 = 101 | Row 4 = 110 | Row 2 = 011 |
| matrix 1, | | | | | | |
| where | | | | | | |
| type = 1 | | | | | | |
| Weighting | 0 (+1) | 1 (−1) | Row 2 = 000 | Row 3 = 101 | Row 4 = 110 | Row 1 = 011 |
| matrix 2, | | | | | | |
| where | | | | | | |
| type = 0 | | | | | | |

The weighting matrix of 8×8 jointly indicated by the second segment (the bit 3 to the bit 15) and the third segment (the bit 16 to the bit 18) is implemented in the following manner.

The weighting matrix of 4×4 and the weighting matrix of 2×2 indicated by the additional three bits (the bit 16 to the bit 18) jointly indicate (or represent) the corresponding weighting matrix of 8×8. Table 4 is a mapping relationship table between the additional three bits (the bit 3 to the bit 15, namely, a 13-bit binary number) and the matrix of 2×2. The mapping relationship table 4 may be predefined between the AP and the STA and known to both the AP and the STA. The bit 16 indicate a category, and the bit 17 and the bit 18 indicate the matrix of 2×2. Therefore, the weighting matrix P₈ₓ₈ of 8×8 can satisfy the following formula:

$${P}_{8 \times 8} = {P}_{4 \times 4} ⊗ [ \begin{matrix}{a}_{3} & {b}_{3} \\ {c}_{3} & {d}_{3}\end{matrix} ]$$

Herein, P₄ₓ₄ represents the weighting matrix of 4×4, and the symbol “⊗” represents a Kronecker product (Kronecker product), that is, matrix elements can be multiplied and dimensions can be expanded, and

$$[ \begin{matrix}{a}_{3} & {b}_{3} \\ {c}_{3} & {d}_{3}\end{matrix} ]$$

may be the matrix of 2×2 in the following Table 4.

Therefore, the AP may indicate (or represent)

$$[ \begin{matrix}{a}_{3} & {b}_{3} \\ {c}_{3} & {d}_{3}\end{matrix} ]$$

by using an additional 3-bit (the bit 16 to the bit 18) sequence based on a bit sequence of the indicated weighting matrix of 4×4, that is, can obtain a bit sequence of the indicated (or represented) weighting matrix of 8×8.

TABLE 4

Bit 17 and bit 18

| Bit 16 | 00 | 01 | 10 | 11 |
|---|---|---|---|---|
| 0 | +1 +1 | +1 +1 | +1 −1 | −1 +1 |
| | +1 −1 | −1 +1 | +1 +1 | +1 +1 |
| 1 | −1 −1 | −1 −1 | −1 +1 | +1 −1 |
| | −1 +1 | +1 −1 | −1 −1 | −1 −1 |

In this embodiment of this application, one row of the weighting matrix corresponds to a weighting sequence of one stream of sensing sequence.

The following describes, by using the weighting matrix of 4×4 indicated by the bits in the second segment in the 19 bits as an example, in detail how the receiver STA 1 (where the STA 1 serves as a transmitter of a sensing signal) determines the corresponding weighting matrix of 4×4 by using a sequence of the bits in the second segment in the 19 bits included in the sensing subelement.

The AP configures two groups of matrices in the sensing subelements in the sensing measurement setup request message, that is, the subelement ids are 2 and 3. The sequence of the bits in the second segment (namely, the bit 16 to the bit 18) in the 19 bits with the subelement id 2 indicates the weighting matrix 1 of 4×4. The sequence of the bits in the second segment (namely, the bit 16 to the bit 18) in the 19 bits with the subelement id 3 indicates the weighting matrix 2 of 4×4.

As shown in FIG. 8B, when the subelement id is 2, the configured sequence of the 19 bits is 101 1 101 011 000 110 010. On a STA side, the weighting matrix 1 corresponding to the sequence of the bits in the second segment may be determined based on the sequence of the bits in the second segment in the 19 bits and with reference to the mapping relationship shown in Table 3A. When the subelement id is 3, the configured sequence of the 19 bits is 011 0 011 000 101 110 100. On a STA side, the weighting matrix 2 corresponding to the sequence of the bits in the second segment may be determined based on the sequence of the bits in the second segment in the 19 bits and with reference to the mapping relationship shown in Table 3A. Rows of the determined weighting matrix 1 and the determined weighting matrix 2 are shown in Table 3B.

Subsequently, in an SR2SI transmission scenario, when the STA 1 sends four streams of SR2SI NDP sequences (each stream of SR2SI NDP sequence includes four HE-LTF symbols) to the AP. In a front-end time sequence, four streams of SR2SI NDP 1 sequences may be separately weighted by using weighting sequences in four rows of the weighting matrix 1, and then sent to the AP through corresponding channels. To be specific, four symbols in the first stream of SR2SR NDP 1 sequence are weighted by using the weighting sequence in the row 1 of the weighting matrix 1, four symbols in the second stream of SR2SR NDP 1 sequence are weighted by using the weighting sequence in the row 2 of the weighting matrix 1, four symbols in the third stream of SR2SR NDP 1 sequence are weighted by using the weighting sequence in the row 3 of the weighting matrix 1, and four symbols in the fourth stream of SR2SRNDP 1 sequence are weighted by using the weighting sequence in the row 4 of the weighting matrix 1. In a back-end time sequence, four streams of SR2SR NDP 2 sequences may be separately weighted by using weighting sequences in four rows of the weighting matrix 2, and then sent to the AP through corresponding channels. That is, four symbols in the first stream of SR2SR NDP 2 sequence are correspondingly weighted by using the weighting sequence in the row 1 of the weighting matrix 2, four symbols in the second stream of SR2SR NDP 2 sequence are correspondingly weighted by using the weighting sequence in the row 2 of the weighting matrix 2, four symbols in the third stream of SR2SR NDP 2 sequence are correspondingly weighted by using the weighting sequence in the row 3 of the weighting matrix 2, and four symbols in the fourth stream of SR2SR NDP 2 sequence are correspondingly weighted by using the weighting sequence in the row 4 of the weighting matrix 2.

In the foregoing, the example in which the four streams of SR2SR NDP sequences of the STA 1 (each SR2SR NDP sequence includes four HE-LTF symbols) are weighted and transmitted by using the weighting matrix of 4×4 is used to describe the solution. In actual application, the four streams of SR2SI NDP sequences may also correspond to those sent by different STAs to the AP, and weighting processing of an SR2SI NDP of each stream may also be implemented with reference to the foregoing weighting manner.

In step S601, an AP side may predefine different weighting matrices (for example, a weighting matrix of 2×2, a weighting matrix of 4×4, and a weighting matrix of 8×8), and indicate the weighting matrices to the STA 1 in the foregoing implementations.

In a possible implementation, a response bit may be further added to the sensing element in the sensing measurement setup request message, and the response bit may indicate how to use a specific weighting matrix used by each stream of sensing sequence that needs to be sent by the STA 1 during sensing.

In a possible implementation, if a sensing participant includes not only the STA 1 but also a STA 2, the AP may further send a sensing measurement setup request message to the STA 2. In this implementation, the STA 2 is similar to the STA 1. For details, refer to the steps corresponding to the STA 1. Details are not described herein again.

In the foregoing steps, the AP can effectively indicate the plurality of predefined weighting matrices to each valid STA, for subsequent weighting.

In Embodiment 1, the sensing participant may not be limited to the STA 1 and the STA 2, and may further include another communication apparatus (for example, the following STA 3). In this case, the AP may indicate a weighting matrix to the another communication apparatus by referring to the foregoing manner of indicating the weighting matrix to the STA 1 (or the STA 2). Details are not described herein again.

S602: The STA 1 sends a sensing measurement setup response message to the AP.

Correspondingly, the AP receives the sensing measurement setup response message of the STA 1, where the sensing measurement setup response message indicates that the STA 1 participates in sensing.

In a possible implementation, if the sensing measurement setup request message sent by the AP and received by the STA 1 includes the 1-bit signaling (which may be equivalent to the first indication information in the solution in FIG. 5) indicating to use the weighted collaborative sensing mode, correspondingly, the sensing measurement setup response message returned by the STA 1 to the AP may further indicate whether the STA 1 supports to use the weighted collaborative sensing mode.

For example, FIG. 7B shows a frame structure of the sensing measurement setup response message. When a status code (Status Code) feedback (or indication) is “SUCCESS_WEIGHTED_JOINT_TRANSMISSION (SUCCESS_WEIGHTED_JOINT_TRANSMISSION)”, it indicates to support to use the weighted collaborative sensing mode (that is, joint spatial stream transmission performed using additional weighting). Otherwise, when the status code (Status Code) feedback (or indication) is another state, it indicates not to support the weighted collaborative sensing mode.

In a possible implementation, the STA 2 also sends a sensing measurement setup response message to the AP. In this implementation, the STA 2 is similar to the STA 1. For details, refer to the steps corresponding to the STA 1. Details are not described herein again.

In Embodiment 1, the sensing participant is not limited to the foregoing STA 1 and STA 2, and may further include the another communication apparatus (for example, the STA 3). The AP may further send a sensing measurement setup request message to the another communication apparatus (for example, the STA 3), and receive a sensing measurement setup response message from the another communication apparatus (for example, the STA 3). In addition, the sensing measurement setup request information and the sensing setup response message may be designed with reference to the sensing measurement setup request information received by the STA 1 (or the STA 2) and the sensing measurement setup response message returned by the STA 1 (or the STA 2). Details are not described herein one by one again.

The foregoing steps S601 and S602 belong to a phase of setting up sensing measurement between the AP and each STA. The following steps belong to a sensing measurement phase.

S603: The AP sends a sensing poll trigger frame to the STA 1, where the sensing poll trigger frame indicates to use a predefined weighting matrix.

In a possible implementation, one-bit signaling (which is equivalent to the second indication information in the solution in FIG. 5) is added to the sensing poll trigger frame (poll trigger frame) (which is equivalent to the second sensing frame in the solution in FIG. 5), and the one-bit signaling indicates weighting and transmission.

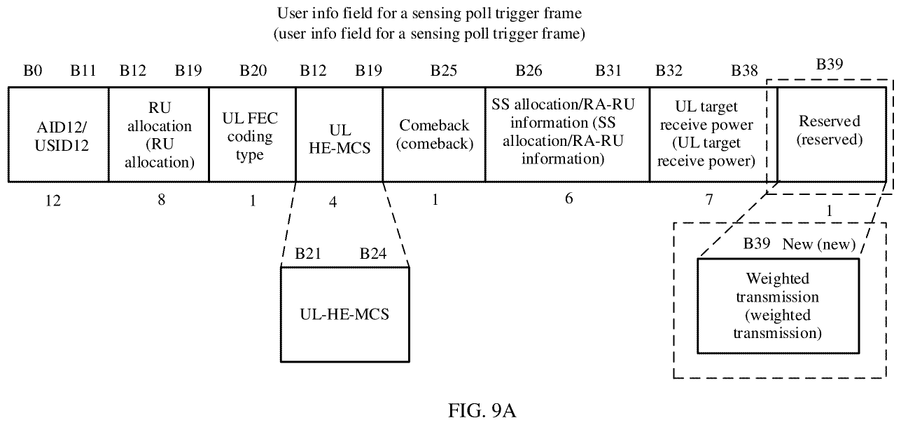

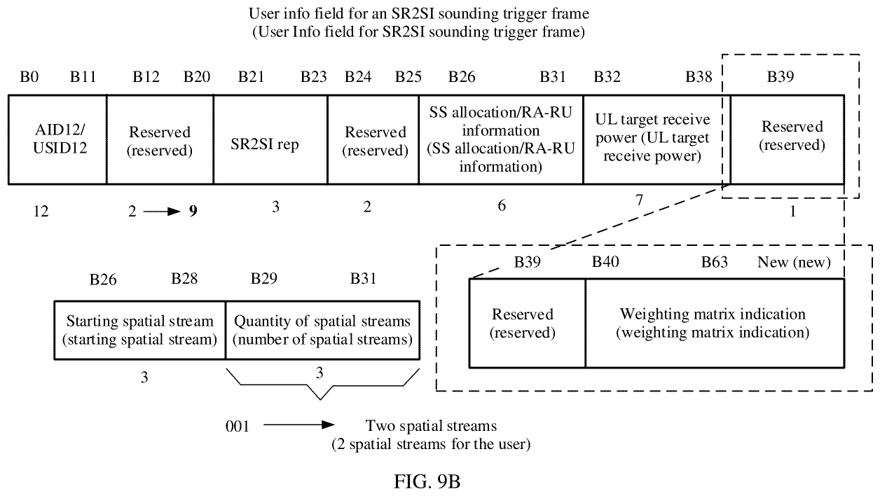

For example, as shown in FIG. 9A, one bit is added to a sensing poll trigger frame for a sensing instance. When the bit is set to 1, it indicates to use (or enable) a weighting matrix on a TP sounding NDP in the measurement instance for weighting and transmission; or when the bit is not set to 1, it indicates not to use (or disable) a weighting matrix in the measurement instance for weighting and transmission.

In a possible implementation, the AP may further send a sensing poll trigger frame to the STA 2. Correspondingly, the STA 2 receives the sensing poll trigger frame, where the sensing poll trigger frame may also indicate weighting information for weighting each stream of NDP sequence of the STA 2. For a specific design, refer to the sensing poll trigger frame sent by the AP to the STA 1. Details are not described herein again.

S604: The AP sends a sensing sounding trigger frame to the STA 1, where the sensing sounding trigger frame indicates weighting information of each stream of NDP sequence (namely, a weighting sequence correspondingly used by each stream) of the STA 1.

For example, in an SR2SI sensing scenario, the AP serves as a sensing initiator (SI), the STA 1 serves as a sensing responder (SR) or participant, and the STA 1 also serves as a transmitter of a sensing signal.

In a possible implementation, the AP sends a sensing sounding trigger frame to the STA 1, where the sensing sounding trigger frame includes preset bit information, and the preset bit information indicates weighting information (which is equivalent to the target weighting sequences in the solution shown in FIG. 5) used by NDP sequences (which are equivalent to the sensing sequences in the solution shown in FIG. 5) of N streams of the STA 1, where N is a positive integer.

For example, as shown in FIG. 9B, in a structure of the SR2SI sounding frame received by the STA 1, there is a segment of bit information (for example, 24 bits to x, which configures a quantity of matrices, where x is a positive integer) that is long enough. The segment of bit information indicates weighting information used by a sensing sequence (NDP sequence) of each stream of the STA 1. Similarly, when the another STA (for example, the STA 2) serves as a transmitter of a sensing signal, the AP may also indicate, to the another STA (for example, the STA 2) in a similar manner of indicating to the STA 1, weighting information used by a sensing sequence (NDP sequence) of each stream.

The following describes in detail how the AP indicates, to the STA by sending the sounding trigger frame, the weighting information of each stream of sensing sequence of the STA.

For example, in an SR2SI sensing scenario (that is, the STA serves as a transmitter of a sensing signal, and the AP serves as a receiver of the sensing signal), it is assumed that there are four STAs serving as transmitters of sensing signals, each STA sends one sensing stream (namely, one stream of NDP sequence), and each sensing stream includes four sensing symbols. In this case, the AP receives four sensing streams simultaneously.

In the sensing measurement setup phase, the AP may predefine two weighting matrices and indicate (send) the two weighting matrices to the four STAs by using sensing measurement setup request messages. Further, in the sensing measurement phase (namely, in step S604), the AP separately sends an SR2SI sensing sounding trigger frame (SR2SI sounding trigger frame) to the four STAs. Information included in a user info field (user info field) for each SR2SI sounding trigger frame may indicate weighting information for a sensing stream sent by a corresponding STA.

Refer to FIG. 9B. The following uses the SR2SI sounding trigger frame sent by the AP to the STA 1 as an example to describe in detail how the SR2SI sounding trigger frame indicates weighting information of each sensing stream (each sensing stream corresponds to one row of a weighting sequence in a weighting matrix) of the STA 1. The following is included.

First, an SS allocation field (which belongs to an original field) may include a field indicating a quantity N of sensing streams sent by the STA 1. If last three bits in the SS allocation field are defined as 000, one sensing stream is indicated; if last three bits in the SS allocation field are defined as 001, two sensing streams are indicated; and the rest may be deduced by analogy. For example, if the quantity N of sensing streams that need to be sent by the STA 1 is 1, the AP sends the SR2SI sounding trigger frame to the STA 1, where the last three bits (B29 to B31) in the SS allocation field are 000.

Then, the user info field for the SR2SI sounding trigger frame needs to indicate which weighting matrix is used by the N sensing streams. That is, an 8-bit field (which may be named as a weighting matrix indication weighting matrix indication) may be added to the field, to indicate a number of the used weighting matrix. For example, if it needs to indicate that the STA 1 uses a second weighting matrix, the 8-bit field is 00000001.

Finally, the user info field for the SR2SI sounding trigger frame further indicates which row in the weighting matrix is used to weight the N sensing streams. In this field, a 24-bit field (which may be named as spatial stream weight) may be added, to indicate, which row, in the weighting matrix, used for each sensing stream sent by the STA 1. For example, in the added 24-bit field, each 3-bit field indicates which row, in the weighting matrix, used for one sensing stream. If first 3-bit field indicates a fifth row, in the weighting matrix, used for a first sensing stream sent by the STA 1, the first 3-bit field is 100. If the STA 1 sends only one sensing stream, only the first 3-bit field in the added 24-bit field is valid, and last 21-bit field is reserved (reserved).

In a possible implementation, the AP may further send a sensing sounding trigger frame to the STA 2. Further, the STA 2 may determine, based on weighting information indicated by the sensing sounding trigger frame, a weighting sequence used for each stream of NDP sequence of the STA 2. For this, refer to a design of the sensing sounding trigger frame sent by the AP to the STA 1. Details are not described herein again.

In a possible implementation, in an SR2SR sensing mode, the sensing sounding trigger frame is an SR2SR sensing sounding trigger frame. The SR2SR sensing sounding trigger frame further includes receiving information, and the receiving information is used by the receiver of the sensing signal (the following uses the STA 3 as an example of the receiver of the sensing signal). The receiving information may indicate but is not limited to indicating one or more of the following: the quantity of NDP sequence streams sent by the STA 1, the weighting information used by each stream of NDP sequence (namely, a row in the weighting matrix used by each stream) of the STA 1, and an identifier (for example, an ID) of the NDP sequence stream of the STA 1.

In a possible implementation, in the SR2SR sensing mode, the STA 3 serves as the receiver of the sensing signal. In this case, the AP further sends an SR2SR sensing sounding trigger frame to the STA 3.

S605: The STA 1 performs weighting processing on each stream of NDP sequence based on the weighting information (namely, the weighting sequence correspondingly used by each stream) indicated by the sensing sounding trigger frame, to obtain each stream of weighted NDP sequence.

In a possible implementation, the STA 1 may determine, based on the sensing sounding trigger frame, a target weighting sequence, in the weighting matrix (namely, one row of the weighting matrix, where a quantity of symbols included in each stream of NDP sequence is equal to a quantity of weighting value elements in the target weighting sequence), used for each stream of NDP sequence. Further, the STA 1 performs weighting processing on each stream of NDP sequence by using the target weighting sequence corresponding to each stream, to obtain a corresponding stream of weighted NDP sequence.

S606a: The STA 1 sends each stream of weighted NDP sequence to the AP.

Correspondingly, the AP receives each stream of weighted NDP sequence of the STA 1.

In a possible implementation, step S606a is performed in an SR2SI sensing mode. The STA 1 serves as a sensing transmitter, and the AP serves as a sensing receiver.

S606b: The STA 1 sends each stream of weighted NDP sequence to the STA 3.

Correspondingly, the STA 3 receives each stream of weighted NDP sequence of the STA 1.

In a possible implementation, step S606b is performed in an SR2SR sensing mode. The STA 1 serves as a sensing transmitter, and the STA 3 serves as a sensing receiver.

In Embodiment 1, descriptions are provided by using an example in which the STA 1 serves as the sensing transmitter. In practice, there may be one or more other sensing transmitters STAs (for example, the STA 2). For steps performed by each sensing transmitter, refer to the steps about the STA 1. Details are not described herein one by one again.

In this embodiment of this application, the sensing receiver (the AP or the STA 3) may receive a plurality of weighted sensing streams (namely, multiple streams of weighted NDP sequences). These weighted sensing streams may all come from the same STA 1, or may come from different STAs (including the STA 1).

For example, if the AP receives four weighted sensing streams, the four weighted sensing streams may come from the following cases.

Case 1: The four weighted sensing streams come from a same STA.

Case 2: The four weighted sensing streams come from different STAs.

For example, the four weighted sensing streams come from two STAs, and each STA sends two sensing streams; or the four weighted sensing streams come from three STAs, and two STAs send one weighted sensing stream, and the other STA sends two weighted sensing streams; or the four weighted sensing streams come from four STAs, and each STA sends one weighted sensing stream.

In addition, in this embodiment of this application, a quantity of sensing streams transmitted on a sensing transmitter side may be any value from 1 to 8, but is not limited thereto. In other words, in this embodiment of this application, transmission of one to eight streams of sensing sequences is used as an example, and the quantity of streams is not limited to eight in actual application.

S607a: The AP may obtain, by solving based on each stream of weighted NDP sequence of the STA 1 and the weighting information of each stream of NDP sequence (namely, the weighting sequence correspondingly used by each stream), information about a transmission channel corresponding to each stream of NDP sequence.

Step S607a corresponds to step S606a.

For example, weighted NDP 1 sequences of four streams (four streams of weighted NDP sequences 1 are obtained by weighting by using a weighting matrix 1) received by the AP are represented by the following formulas:

$${y}_{1} [ n ] = ( - {h}_{1} [ n ] + {h}_{2} [ n ] + {h}_{3} [ n ] - {h}_{4} [ n ] )$$

$${y}_{2} [ n ] = ( - {h}_{1} [ n ] - {h}_{2} [ n ] + {h}_{3} [ n ] + {h}_{4} [ n ] )$$

$${y}_{3} [ n ] = ( + {h}_{1} [ n ] + {h}_{2} [ n ] + {h}_{3} [ n ] + {h}_{4} [ n ] )$$

$${y}_{4} [ n ] = ( + {h}_{1} [ n ] - {h}_{2} [ n ] + {h}_{3} [ n ] - {h}_{4} [ n ] )$$

The weighting matrix 1

$$( {P}_{4 \times 4}^{( 1 )} )$$

is as follows:

$${P}_{4 \times 4}^{( 1 )} = [ \begin{matrix}- 1 & - 1 & + 1 & + 1 \\ + 1 & - 1 & + 1 & - 1 \\ + 1 & + 1 & + 1 & + 1 \\ - 1 & + 1 & + 1 & - 1\end{matrix} ]$$

Then, the AP may obtain, by solving based on the weighting matrix 1 and the four streams of weighted NDP 1 sequences, information about channels corresponding to the four streams of weighted NDP 1 sequences, that is, the information about the channels may be represented by the following formulas:

$${\hat{h}}_{1} [ n ] = ( - {y}_{1} [ n ] - {y}_{2} [ n ] + {y}_{3} [ n ] + {y}_{4} [ n ] ) / 4$$

$${\hat{h}}_{2} [ n ] = ( + {y}_{1} [ n ] - {y}_{2} [ n ] + {y}_{3} [ n ] - {y}_{4} [ n ] ) / 4$$

$${\hat{h}}_{3} [ n ] = ( + {y}_{1} [ n ] + {y}_{2} [ n ] + {y}_{3} [ n ] + {y}_{4} [ n ] ) / 4$$

$${\hat{h}}_{4} [ n ] = ( - {y}_{1} [ n ] + {y}_{2} [ n ] + {y}_{3} [ n ] - {y}_{4} [ n ] ) / 4$$

Weighted NDP 2 sequences of four streams (weighted NDP sequences 2 of four streams are obtained by weighting by using a weighting matrix 2, and an NDP 1 sequence and a DDP 2 sequence sent for each stream are sent in different time periods) received by the AP are represented by the following formulas:

$${y}_{1} [ n ] = ( - {h}_{1} [ n ] - {h}_{2} [ n ] + {h}_{3} [ n ] + {h}_{4} [ n ] )$$

$${y}_{2} [ n ] = ( - {h}_{1} [ n ] + {h}_{2} [ n ] + {h}_{3} [ n ] + {h}_{4} [ n ] )$$

$${y}_{3} [ n ] = ( + {h}_{1} [ n ] - {h}_{2} [ n ] + {h}_{3} [ n ] + {h}_{4} [ n ] )$$

$${y}_{4} [ n ] = ( - {h}_{1} [ n ] - {h}_{2} [ n ] + {h}_{3} [ n ] - {h}_{4} [ n ] )$$

The weighting matrix 2

$$( {P}_{4 \times 4}^{( 2 )} )$$

is as follows:

$${P}_{4 \times 4}^{( 2 )} = [ \begin{matrix}- 1 & + 1 & + 1 & + 1 \\ + 1 & + 1 & + 1 & - 1 \\ - 1 & - 1 & + 1 & - 1 \\ - 1 & + 1 & - 1 & - 1\end{matrix} ]$$

Then, the AP may obtain, by solving based on the weighting matrix 2 and the four streams of weighted NDP 2 sequences, information about channels corresponding to the four streams of weighted NDP 2 sequences, that is, the information about the channels may be represented by the following formulas:

$${\hat{h}}_{1} [ n ] = ( - {y}_{1} [ n ] - {y}_{2} [ n ] + {y}_{3} [ n ] - {y}_{4} [ n ] ) / 4$$

$${\hat{h}}_{2} [ n ] = ( - {y}_{1} [ n ] + {y}_{2} [ n ] - {y}_{3} [ n ] - {y}_{4} [ n ] ) / 4$$

$${\hat{h}}_{3} [ n ] = ( - {y}_{1} [ n ] + {y}_{2} [ n ] + {y}_{3} [ n ] + {y}_{4} [ n ] ) / 4$$

$${\hat{h}}_{4} [ n ] = ( + {y}_{1} [ n ] + {y}_{2} [ n ] + {y}_{3} [ n ] - {y}_{4} [ n ] ) / 4$$

In step S607a, the solution is described by using an example in which the AP processes each stream of weighted NDP sequence from the STA 1. Actually, the multiple streams of weighted NDP sequences received by the AP are not limited to that from the STA 1. For a manner in which the AP solves, based on the weighted NDP sequences, information about corresponding channels, refer to the solving manner corresponding to the STA 1 in this step. Details are not described herein again.

S607b: The STA 3 may obtain, by solving based on each stream of weighted NDP sequence of the STA 1 and the weighting information of each stream of NDP sequence (namely, the weighting sequence correspondingly used by each stream), information about a transmission channel corresponding to each stream of NDP sequence.

Step S607b corresponds to step S606b.

Step S607b may be performed with reference to step S607a. Details are not described herein again.

For example, the STA 3 determines, based on information indicated in the SR2SR sounding trigger frame, weighting sequences used by four streams of sensing sequences (weighting sequences used by four streams of sensing sequences may form a target weighting matrix of 4×4) and that the STA 1 needs to send the four streams of NDP sequences (each stream of NDP sequence includes four HE-LTF symbols). Further, in S606b, the STA 3 receives the four streams of weighted NDP sequences (each stream includes four weighted HE-LTF symbols) of the STA 1 simultaneously. In this case, in S607b, the STA 3 may obtain, by solving based on the target weighting matrix of 4×4 and the four streams of weighted NDP sequences, information about channels corresponding to the four streams.

Through the foregoing steps, the sensing receiver (namely, the AP or the STA 3) can sense a channel response corresponding to each sensing stream of the STA 1 for each row of the weighting sequence. In the sensing measurement setup phase, the AP negotiates the predefined weighting information with each sensing participant (the STA 1 and the STA 2), and the weighting information is negotiated by using an encrypted frame. A third-party user does not know the weighting information used by a transmitter party of the sensing signal, and therefore cannot obtain the correct information about the channel, and cannot effectively perform a sensing task to obtain sensing information. This can effectively avoid leakage of user privacy information in the sensing information.

In Embodiment 1, in a sensing measurement setup process, the sensing initiator (AP) side may design a plurality of weighting matrices in advance and send the weighting matrices to the sensing responder (STA). In addition, in a sensing measurement process, the AP may indicate, to the STA, the previously negotiated weighting matrix, so that the sent sensing sequences are weighted and then transmitted. In this way, after receiving the weighted sensing sequences, the receiver can effectively solve and obtain the information about the channels. Another third party does not know the predefined weighting matrix for the multiple streams of sensing sequences, and therefore cannot correctly solve and obtain the information about the corresponding channels, and cannot effectively perform the sensing task to obtain the sensing information. Therefore, this solution can effectively resolve leakage of the user privacy information in the sensing information through negotiation of the weighting matrix in advance and the collaborative transmission manner.

### Embodiment 2

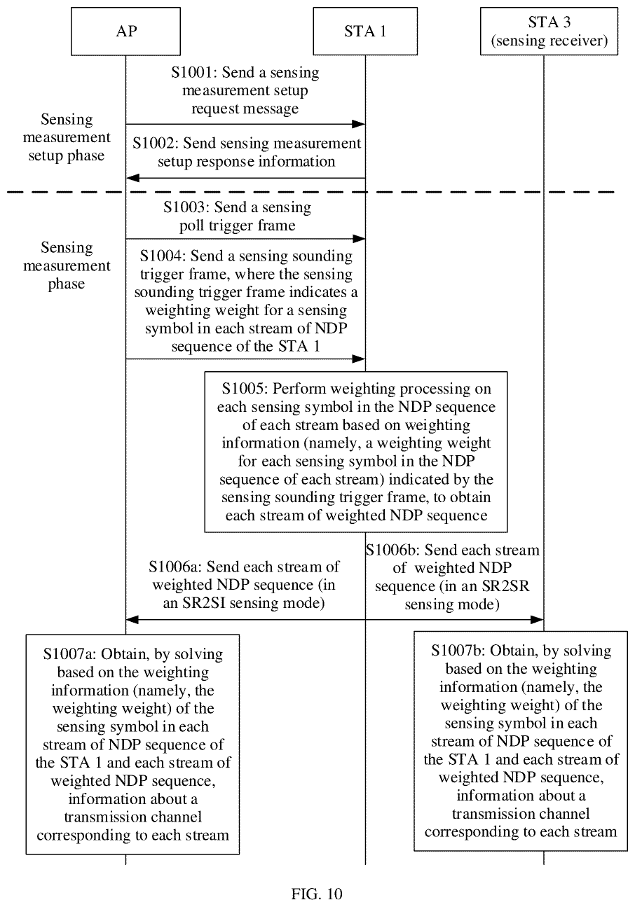

Embodiment 2 is mainly described based on Implementation solution 2 shown in FIG. 5. That is, in sensing measurement setup, the first apparatus may first send, to the second apparatus, the request message for requesting to set up sensing measurement, to indicate the phase rotation codebook of the sensing sequence to the second apparatus; and further, the first apparatus may indicate, to the second apparatus, the phase rotation value used by each sensing symbol in each stream of sensing sequence, to implement weight and transmission of the N streams of sensing sequences. In Embodiment 2, the first apparatus is an AP as an example, the AP serves as a sensing initiator (SI), the second apparatus is a STA 1 (or a STA 2) as an example, the STA 1 (or the STA 2) serves as a sensing responder, and STAs may perform collaborative sensing and use a multi-stream transmission manner. As shown in FIG. 10, a procedure of Embodiment 2 is as follows.

S1001: The AP sends a sensing measurement setup request message to the STA 1.

In a possible implementation, the sensing measurement setup request message (which is equivalent to the first request message in the solution in FIG. 5) includes 1-bit signaling, and the 1-bit signaling indicates to use a weighted collaborative sensing mode. For example, for details about the 1-bit signaling located in the sensing measurement setup request frame, refer to FIG. 7A in step S601.

In a possible implementation, the sensing measurement setup request message further includes a variable-length sensing subelements field, and the variable-length sensing subelements field indicates a weighting codebook of the NDP sequence (namely, the sensing sequence).

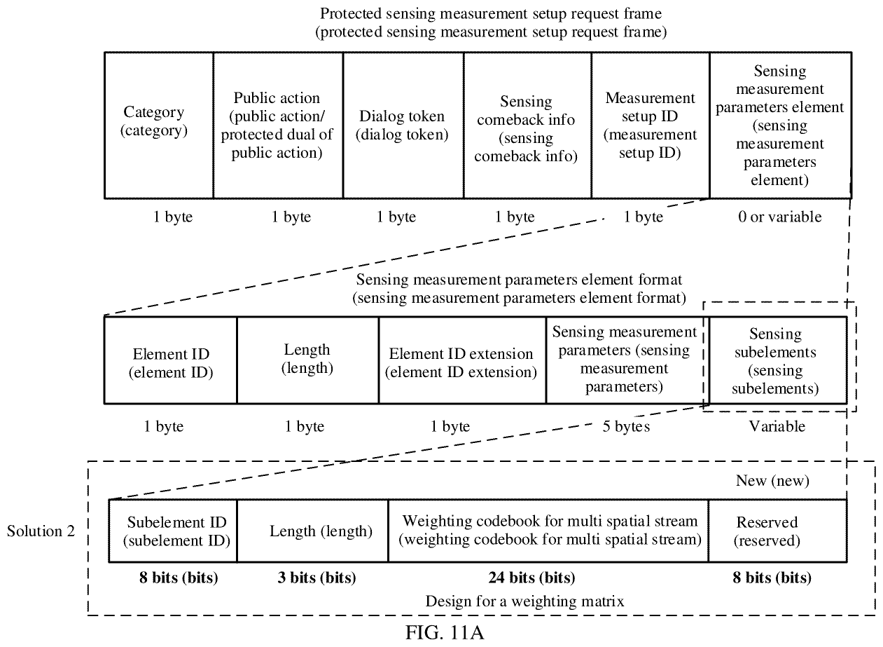

For example, as shown in FIG. 11A, the variable-length sensing subelements field includes six bytes (a total of 48 bits), where in the six bytes (the total of 48 bits), eight bits indicate a sensing subelement ID, and 24 bits indicate the weighting codebook of the sensing sequence.

More IDs may be added in the sensing subelement ID based on the conventional technology (the sensing subelement ID is 0 or 1). As shown in Table 1, the sensing subelement ID may be 2 to x, where x is a positive integer. Different sensing subelements may indicate different weighting codebooks.

In a possible implementation, the STA 1 modulates the HE-LTF symbols (namely, sensing symbols) in each stream of NDP sequence by using 8 phase shift keying 8PSK, to implement weighting. Therefore, in 24 bits in the sensing subelement, every three bits may represent one weighting weight (namely, a phase rotation value).

For example, as shown in FIG. 11B, the sensing symbols are weighted by using 8PSK modulation, and there are a total of eight weights (namely, phase rotation values).

The following Table 5A is an original representation solution of the eight weights. Based on Table 5A, after an order of indexes and corresponding indication bits are rearranged, the following Table 5B is obtained. In Embodiment 2 of this application, the sensing subelement in the sensing measurement setup request frame may be configured based on content shown in the following Table 5B.

TABLE 5A

| | All possible weights | | | | | | | |
|---|---|---|---|---|---|---|---|---|
| Codebook (codebook) | ${e}^{j \frac{0}{4} π}$ | ${e}^{j \frac{1}{4} π}$ | ${e}^{j \frac{2}{4} π}$ | ${e}^{j \frac{3}{4} π}$ | ${e}^{j \frac{4}{4} π}$ | ${e}^{j \frac{5}{4} π}$ | ${e}^{j \frac{6}{4} π}$ | ${e}^{j \frac{7}{4} π}$ |
| Index | 0 | 1 | 2 | 3 | 4 | 5 | 6 | 7 |
| (index) | | | | | | | | |
| Indication | 000 | 001 | 010 | 011 | 100 | 101 | 110 | 111 |
| bit | | | | | | | | |

TABLE 5B

| | All possible weights (scrambling indications) | | | | | | | |
|---|---|---|---|---|---|---|---|---|
| Codebook (codebook) | ${e}^{j \frac{0}{4} π}$ | ${e}^{j \frac{1}{4} π}$ | ${e}^{j \frac{2}{4} π}$ | ${e}^{j \frac{3}{4} π}$ | ${e}^{j \frac{4}{4} π}$ | ${e}^{j \frac{5}{4} π}$ | ${e}^{j \frac{6}{4} π}$ | ${e}^{j \frac{7}{4} π}$ |
| Index | 6 | 1 | 5 | 0 | 2 | 4 | 7 | 3 |
| (index) | | | | | | | | |
| Indication | 110 | 001 | 101 | 000 | 010 | 100 | 111 | 011 |
| bit | | | | | | | | |

For example, in a sensing subelement, a subelement subelement ID is 2. If 24 bits in the sensing subelement are 110 001 101 000 010 100 111 011, weighting weights of each sensing symbol corresponding to the 24 bits are shown in the following Table 6.

TABLE 6

| | All possible weights (scrambling indications) | | | | | | | |
|---|---|---|---|---|---|---|---|---|
| Codebook (codebook) | ${e}^{j \frac{0}{4} π}$ | ${e}^{j \frac{1}{4} π}$ | ${e}^{j \frac{2}{4} π}$ | ${e}^{j \frac{3}{4} π}$ | ${e}^{j \frac{4}{4} π}$ | ${e}^{j \frac{5}{4} π}$ | ${e}^{j \frac{6}{4} π}$ | ${e}^{j \frac{7}{4} π}$ |
| Index | 6 | 1 | 5 | 0 | 2 | 4 | 7 | 3 |
| (index) | | | | | | | | |
| Indication | 110 | 001 | 101 | 000 | 010 | 100 | 111 | 011 |
| bit | | | | | | | | |

In a possible implementation, if a sensing participant includes not only the STA 1 but also a STA 2, the AP may further send a sensing measurement setup request message to the STA 2. In this implementation, the STA 2 is similar to the STA 1. For details, refer to the steps about the STA 1. Details are not described herein again.

In the foregoing steps, the AP may effectively indicate the eight predefined weighting weights to each authorized STA, for subsequent weighting.

In Embodiment 2, the sensing participant may not be limited to the STA 1 and the STA 2, and may further include another communication apparatus. In this case, the AP may indicate weighting weights to the another communication apparatus by referring to the foregoing manner of indicating the weighting weights to the STA 1 (or the STA 2). Details are not described herein again.

S1002: The STA 1 sends a sensing measurement setup response message to the AP.

Correspondingly, the AP receives the sensing measurement setup response message of the STA 1, where the sensing measurement setup response message indicates that the STA 1 participates in sensing.

In a possible implementation, if the sensing measurement setup request message sent by the AP and received by the STA 1 includes the 1-bit signaling (which may be equivalent to the first indication information in the solution in FIG. 5) indicating to use the weighted collaborative sensing mode, correspondingly, the sensing measurement setup response message returned by the STA 1 to the AP may further indicate whether the STA 1 supports to use the weighted collaborative sensing mode.

For example, refer to FIG. 7B. In the frame structure of the sensing measurement setup response message, when a status code (Status Code) feedback (or indication) is “SUCCESS_WEIGHTED_JOINT_TRANSMISSION (SUCCESS_WEIGHTED_JOINT_TRANSMISSION)”, it indicates to support to use the weighted collaborative sensing mode (that is, joint spatial stream transmission performed using additional weighting). Otherwise, when the status code (Status Code) feedback (or indication) is another state, it indicates not to support the weighted collaborative sensing mode.

In a possible implementation, the sensing participant STA 2 send sensing measurement setup response information to the AP. In this implementation, the STA 2 is similar to the STA 1. For details, refer to the steps about the STA 1. Details are not described herein again.

In Embodiment 2, the sensing participant is not limited to the foregoing STA 1 and STA 2, and may further include the another communication apparatus (for example, a STA 3). The AP may further send a sensing measurement setup request message to the another communication apparatus (for example, the STA 3), and receive a sensing measurement setup response message from the another communication apparatus (for example, the STA 3). In addition, the sensing measurement setup request information and the sensing setup response message may be designed with reference to the sensing measurement setup request information received by the STA 1 (or the STA 2) and the sensing measurement setup response message returned by the STA 1 (or the STA 2). Details are not described herein one by one again.

The foregoing steps S1001 and S1002 belong to a phase of setting up sensing measurement between the AP and each STA. The following steps belong to a sensing measurement phase.

S1003: The AP sends a sensing poll trigger frame to the STA 1, where the sensing poll trigger frame indicates to use a predefined weighting weight.

In a possible implementation, one-bit signaling (which is equivalent to the second indication information in the solution in FIG. 5) is added to the sensing poll trigger frame (which is equivalent to the second sensing frame in the solution in FIG. 5), and the one-bit signaling indicates weighting and transmission.

For example, as shown in FIG. 9A, one bit is added to a sensing poll trigger frame for a sensing instance. When the bit is set to 1, it indicates to use a configured codebook in the sensing instance; or when the bit is not set to 1, it indicates not to use (disable) a configured codebook in the sensing instance for weighting and transmission.

In a possible implementation, the AP may further send a sensing poll trigger frame to the STA 2. Correspondingly, the STA 2 receives the sensing poll trigger frame, where the sensing poll trigger frame may also indicate weighting information for weighting each stream of NDP sequence of the STA 2. For a specific design, refer to the sensing poll trigger frame sent by the AP to the STA 1. Details are not described herein again.

S1004: The AP sends a sensing sounding trigger frame to the STA 1, where the sensing sounding trigger frame indicates a weighting weight for a sensing symbol in each stream of NDP sequence of the STA 1.

In a possible implementation, in a scenario in which a plurality of sensing transmitters STAs (for example, the STA 1 and the STA 2) perform collaborative sensing and use multi-stream transmission, the STA 2 may also receive a sensing sounding trigger frame, and weight, based on the weighting information indicated by the sounding trigger frame, to-be-sent NDP sequence (namely, sensing sequence) of each stream.

In a possible implementation, in an SR2SI sensing mode, the AP sends an SR2SI sounding trigger frame to the STA 1, where the SR2SI sounding trigger frame includes a transmitter user info field, and the transmitter user info field may indicate a weighting weight of a sensing symbol in each stream of NDP sequence of the STA 1.

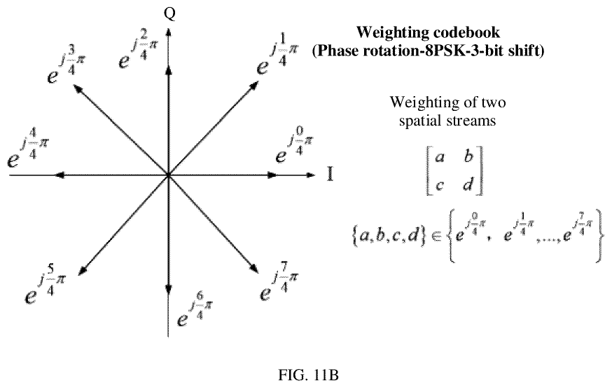

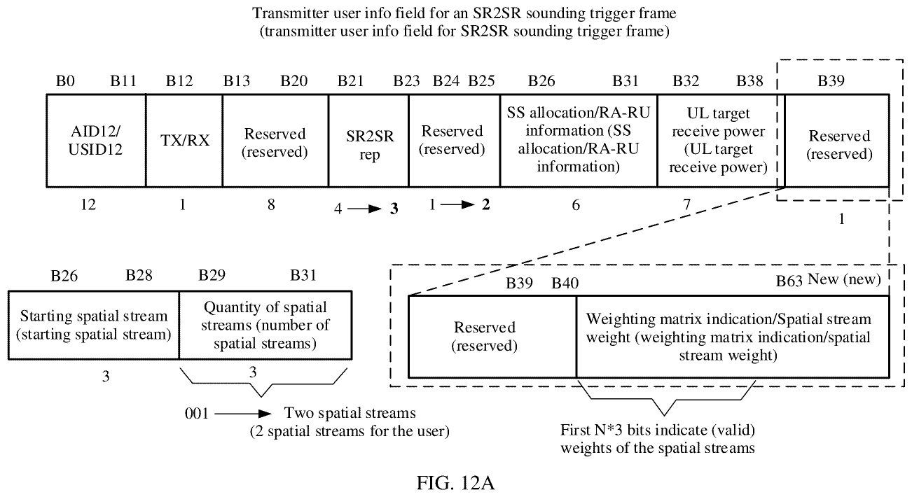

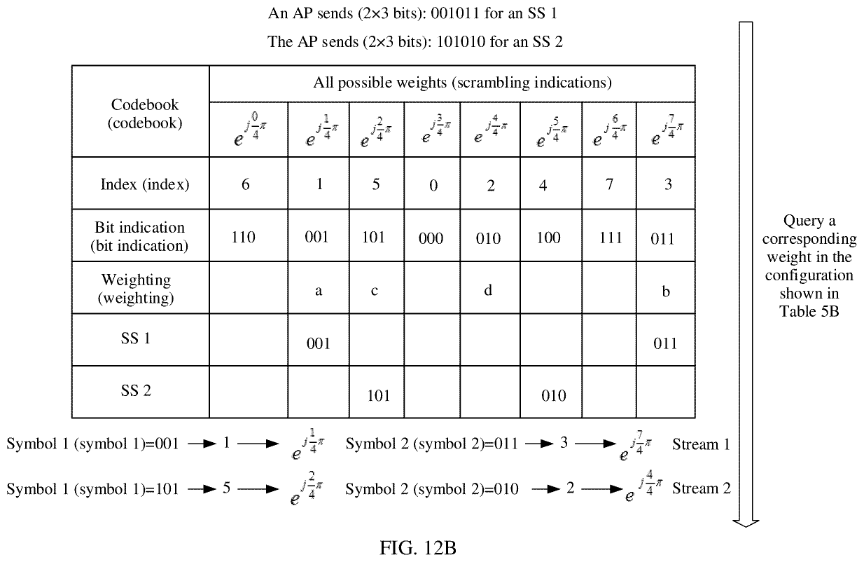

For example, as shown in FIG. 12A, two SRs send sensing sequences to another SR for sensing, namely, SR2SR sensing. In a structure of the SR2SR sounding trigger frame (sent by the SI to the three SRs, where the two SRs are sensing transmitters and one SR is a sensing receiver), a segment of bit space (for example, 24 bits to x, which configures a quantity of matrices, where x is a positive integer) that is long enough indicates weighting information (namely, weight value) used by each sensing symbol in all sensing streams of each SR. For example, when bit sequences in sensing sounding trigger frames sent by the AP to the two SR sensing transmitters are 001011 and 101010, weight values (namely, phase rotation values or phase shift weight values) corresponding to two symbols of each sensing stream (namely, SStream 1 and SStream 2) are shown in FIG. 12B.

In another possible implementation, in an SR2SR sensing mode, in addition to sending SR2SR sounding trigger frames to sensing transmitters (the STA 1 and the STA 2), the AP further sends an SR2SR sounding trigger frame to a sensing receiver (the following uses a STA 3 as the sensing receiver as an example). Therefore, the SR2SR sounding trigger frame includes a transmitter user info field (indicating a weighting weight of a sensing symbol in each stream of NDP sequence of the STA serving as the transmitter) and further includes a receiver user info field (information used by the sensing receiver STA 3). The receiver user info field may indicate but is not limited to indicating one or more of the following:
whether to be multi-stream transmission, a quantity of sent NDP sequence streams (not limited to a quantity of NDP sequence streams sent by the STA 1), weighting information (namely, weights corresponding to each stream) used by each stream of NDP sequence, and an identifier (for example, an ID) of each NDP sequence stream.

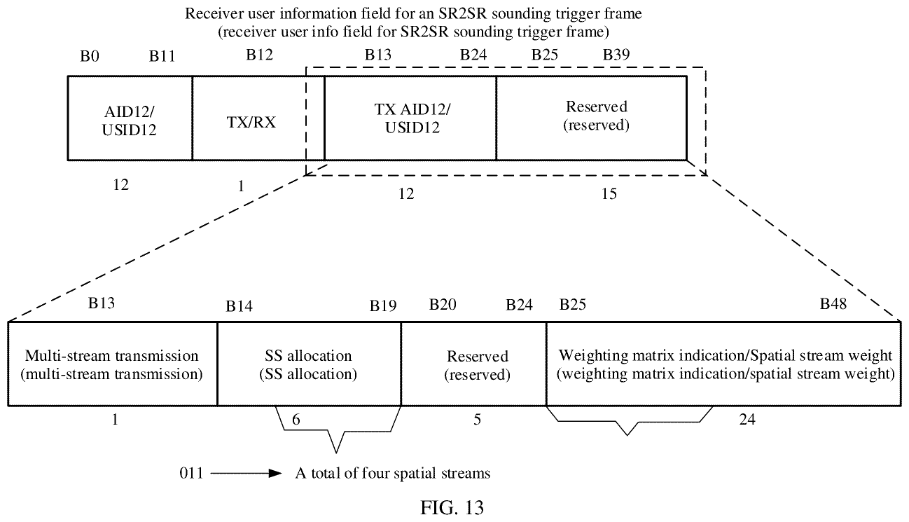

For example, FIG. 13 is a diagram of the receiver user info field for the SR2SR sounding trigger frame (receiver user info field for the SR2SR sounding trigger frame).

The following is how the AP notifies, by using the sensing SR2SR sounding trigger frame (Sounding trigger frame), the sensing receiver SR (for example, the STA 3) of the weighting information used by each stream of NPD sequence (namely, each stream of sensing sequence, which may also be referred to as each sensing stream) of the sensing transmitters.

In the SR2SR sensing mode, that is, the two STAs are the transmitters (which may be referred to as sensing transmitters for short) of sensing signals, and one STA is the receiver (which may be referred to as a sensing receiver for short) of a sensing signal: A total of two STAs (for example, the STA 1 and the STA 2) serve as sensing transmitters, each STA sends one sensing stream, and each sensing stream includes two sensing symbols; and the sensing receiver (for example, the STA 3) receives the two sensing streams simultaneously.

In the sensing measurement setup phase, the AP may predefine a group of weighting values (or referred to as a group of weight values), for example, the eight phase shift weight values shown in Table 5B, and indicate (or transmit) the group of weight values to the three STAs by using the sensing measurement request messages.

In the sensing measurement phase (namely, in step S1004), the AP needs to send SR2SR sounding trigger frames (SR2SR sounding trigger frames) to the two sensing transmitters (for example, the STA 1 and the STA 2) separately. Information included in a transmitter user info field (transmitter user info field) for each SR2SR sounding trigger frame may indicate weighting of one sensing stream that needs to be sent by a corresponding STA (the STA 1 or the STA 2). For this step, refer to the step in Embodiment 1. In this case, the AP further needs to send an SR2SR sounding trigger frame to the sensing receiver (for example, the STA 3). A receiver user info field (receiver user info field) for an SR2SR sounding trigger frame includes information indicating weights used by two sensing streams that need to be received by the receiver STA 3. Refer to FIG. 13. A specific indication case may include the following.

First, a synchronization offset allocation (SS Allocation) field (namely, an original field) in the receiver user info field includes a quantity of sensing streams that need to be received by the receiver STA 3. It is assumed that when last three bits in the SS allocation field are 000, it indicates one stream; when last three bits are 001, it indicates two streams; when last three bits are 010, it indicates three streams; when last three bits are 011, it indicates four streams; and the rest may be deduced by analogy. For example, if there are two transmitters (the STA 1 and the STA 2), and each STA sends one stream, the last three bits in the SS allocation field are 000. In this embodiment, the “stream” may also be referred to as a “spatial stream.”

Then, the receiver user info field for the SR2SI sounding trigger frame needs to indicate weighting information used by the two sensing streams. That is, the receiver user info field may have an 8-bit field (which is an added field, and is named as weighting matrix indication (weighting matrix indication) in FIG. 13), indicating a group of used weighting values (or weight values). For example, if a group of weighting values, namely, a first group of weighting values, is used, the field is set to 00000000.

Finally, the receiver user info field for the SR2SI sounding trigger frame needs to indicate specific weighting values (or weight values) used by the two sensing streams. To be specific, the receiver user info field may be configured with a field (namely, an added field, as shown in FIG. 13, and named as a spatial stream weight (spatial stream weight)) including two 24 bits, to indicate weighting values (namely, the weight values shown in Table 5B) used by two sensing symbols in each of the two sensing streams. First six bits in first 24 bits correspond to weighting values used by two sensing symbols in a first received sensing stream (that is, every three bits indicate a weighting value of the sensing symbol), and first six bits in second 24 bits correspond to weighting values used by two sensing symbols in a second received sensing stream (that is, every three bits indicate a weighting value of the sensing symbol). In the foregoing example, it is assumed that each sensing transmitter (the STA 1 or the STA 2) sends only one sensing stream, and one sensing stream includes two sensing symbols. Therefore, only the first six bits in each 24 bits are valid, and last 18 bits are reserved (reserved) bits.

S1005: The STA 1 performs weighting processing on each sensing symbol in each stream of NDP sequence based on the weighting information (namely, a weighting weight for each sensing symbol in each stream of NDP sequence) indicated by the sensing sounding trigger frame, to obtain each stream of weighted NDP sequence.

In a possible implementation, the STA 1 may determine, based on the sensing sounding trigger frame, a weight value used by each HE-LTF symbol (namely, a sensing symbol) in each stream of NDP sequence. Further, the STA 1 performs weighting processing on each symbol in each stream of NDP sequence based on the weight value corresponding to each symbol in each stream of NDP sequence, to obtain each stream of weighted NDP sequence.

In Embodiment 2, the HE-LTF symbol (the sensing symbol) in the NDP sequence is weighted by using an 8 phase shift keying 8PSK modulation scheme. In this case, the weight value (which may also be referred to as the weighting value) used by each symbol may correspond to the phase shift weight value (or the phase shift amount) of each symbol.

S1006a: The STA 1 sends each stream of weighted NDP sequence to the AP.

In a possible implementation, step S1006a is performed in an SR2SI sensing mode. The STA 1 serves as a sensing transmitter, and the AP serves as a sensing receiver.

S1006b: The STA 1 sends each stream of weighted NDP sequence to the STA 3.

In a possible implementation, step S1006b is performed in an SR2SR sensing mode. The STA 1 serves as a sensing transmitter, and the STA 3 serves as a sensing receiver.

In Embodiment 2, descriptions are provided by using an example in which the STA 1 serves as the sensing transmitter. In practice, there may be one or more other sensing transmitters STAs (for example, the STA 2). For steps performed by each sensing transmitter, refer to the steps about the STA 1. Details are not described herein one by one again.

S1007a: The AP obtains, by solving based on the weighting information (namely, the weighting weight) of the sensing symbol in each stream of NDP sequence of the STA 1 and each stream of weighted NDP sequence, information about a transmission channel corresponding to each stream.

Step S1007a corresponds to step S1006a.

For example, the AP receives two streams of weighted NDP 1 sequences (that is, each stream of weighted NDP 1 sequence includes two weighted symbols).

A weighted symbol 1 and a weighted symbol 2 (the two weighted symbols are obtained by performing weighting by using a first group of weight values {a, b, c, d}) in each stream of weighted NDP 1 sequence may be represented by the following:

$$symbol 1 : {y}_{1} [ n ] = h [ n ] * i \cdot s [ n ] + g [ n ] * - 1 \cdot s [ n ] + {w}_{1} [ n ]$$

$$symbol 2 : {y}_{2} [ n ] = h [ n ] * i \cdot s [ n ] + g [ n ] * - i \cdot s [ n ] + {w}_{2} [ n ]$$

The first group of weight values

$$\{ a , b , c , d \} = \{ {e}^{j \frac{2}{4} π} , {e}^{j \frac{0}{4} π} , {e}^{j \frac{4}{4} π} , {e}^{j \frac{6}{4} π} \} .$$

The AP can obtain, by solving based on the weighted symbols and the first group of weight values, the information about the channels corresponding to the streams. The information about the channels may satisfy the following formulas:

$${y}_{1} [ n ] + i \cdot {y}_{2} [ n ] = 2 i \cdot h [ n ] * s [ n ] + {w}_{1} [ n ] + i \cdot {w}_{2} [ n ] ⟶ \hat{h} [ n ]$$

$${y}_{1} [ n ] - i \cdot {y}_{2} [ n ] = - 2 i \cdot g [ n ] * s [ n ] + {w}_{1} [ n ] - i \cdot {w}_{2} [ n ] ⟶ \hat{g} [ n ]$$

Similarly, the AP receives two streams of weighted NDP 1 sequences (that is, each stream of weighted NDP 1 sequence includes two weighted symbols).

A weighted symbol 1 and a weighted symbol 2 (the two weighted symbols are obtained by performing weighting by using a second group of weight values {a, b, c, d}) in each stream of weighted NDP 1 sequence may be represented by the following:

$$symbol 1 : {y}_{1} [ n ] = h [ n ] * {e}^{j \frac{1}{4} π} \cdot s [ n ] + g [ n ] * + i \cdot s [ n ] + {w}_{1} [ n ]$$

$$symbol 2 : {y}_{2} [ n ] = h [ n ] * {e}^{j \frac{7}{4} π} \cdot s [ n ] + g [ n ] * - 1 \cdot s [ n ] + {w}_{2} [ n ]$$

The second group of weight values

$$\{ a , b , c , d \} = \{ {e}^{j \frac{1}{4} π} , {e}^{j \frac{7}{4} π} , {e}^{j \frac{2}{4} π} , {e}^{j \frac{4}{4} π} \} .$$

The AP can obtain, by solving based on the weighted symbols and the second group of weight values, the information about the channels corresponding to the streams. The information about the channels may satisfy the following formulas:

$${e}^{j \frac{1}{4} π} {y}_{1} [ n ] + {e}^{j \frac{1}{4} π} {y}_{2} [ n ] = 2 \cdot h [ n ] * s [ n ] + {e}^{j \frac{- 1}{4} π} {w}_{1} [ n ] + {e}^{j \frac{1}{4} π} \cdot {w}_{2} [ n ] ⟶ \hat{h} [ n ]$$

$$i \cdot [ n ] + {y}_{2} [ n ] = - 2 \cdot g [ n ] * s [ n ] + i \cdot {w}_{1} [ n ] + {w}_{2} [ n ] ⟶ \hat{g} [ n ]$$

S1007b: The STA 3 obtains, by solving based on the weighting information (namely, the weighting weight) of the sensing symbol in each stream of NDP sequence of the STA 1 and each stream of weighted NDP sequence, information about a transmission channel corresponding to each stream.

Step S1007b corresponds to step S1006b.

Step S1007b may be performed with reference to step S1007a. Details are not described herein again.

Through the foregoing steps, the sensing receiver (namely, the AP or the STA 3) can sense a channel response corresponding to each data stream of the STA 1 for each row of the weighting sequence. Content is negotiated by using an encrypted frame during sensing measurement setup negotiation. Another user does not know the weighting information (namely, the weighting value) used, and therefore cannot obtain the correct information about the channel through solving, and cannot effectively perform a sensing task to obtain sensing information. Therefore, this method can effectively avoid leakage of user privacy information in the sensing information.

In Embodiment 2, in a sensing measurement setup process, the sensing initiator (AP) side may design a plurality of weight values in advance and send the weight values to the sensing responder (STA). In addition, in a sensing measurement process, the AP may indicate, to the STA, the previously negotiated weight values, so that the sensing symbols in the sent sensing sequences are weighted and then transmitted. In this way, after receiving the weighted sensing sequences, the receiver can effectively solve and obtain the information about the channels. Another third party does not know the predefined weight values for weighting each symbol in the multiple streams of sensing sequences, and therefore cannot correctly solve and obtain the information about the channels, and cannot effectively perform the sensing task to obtain the sensing information, where the sensing information includes the user privacy information. Therefore, this solution can protect the user privacy information.

In the foregoing embodiments provided in this application, the methods provided in embodiments of this application are separately described from a perspective of interaction between the devices. To implement functions in the foregoing method provided in embodiments of this application, the first apparatus, the second apparatus, or the third apparatus may include a hardware structure and/or a software module, and implement the foregoing functions in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

In embodiments of this application, division into the modules is an example, and is merely a logical function division. In actual implementation, another division manner may be used. In addition, functional modules in embodiments of this application may be integrated into one processor, or may exist alone physically, or two or more modules may be integrated into one module. The integrated module may be implemented in a form of hardware, or may be implemented in a form of a software functional module.

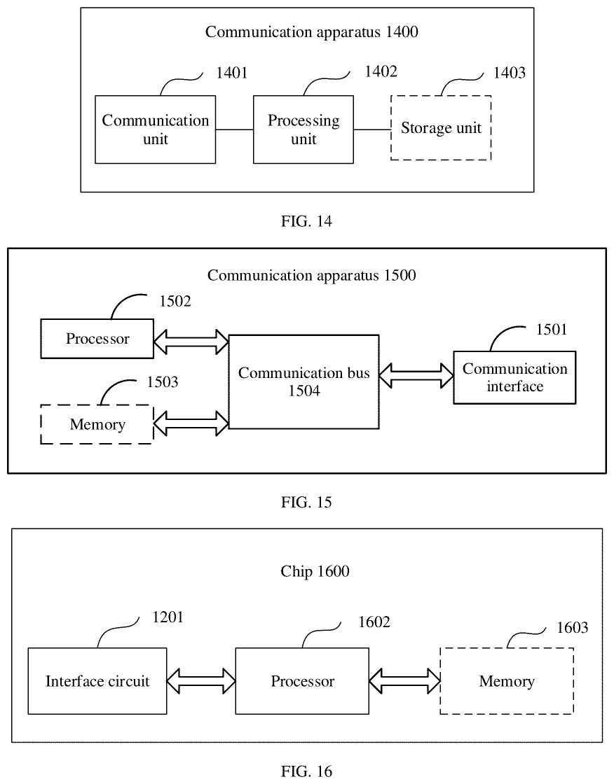

Same as the foregoing idea, as shown in FIG. 14, an embodiment of this application further provides a communication apparatus 1400 configured to implement functions of the first apparatus, the second apparatus, or the third apparatus in the foregoing methods. For example the communication apparatus 1400 may be a software module or a chip system. In this embodiment of this application, the chip system may include a chip, or may include the chip and another discrete component. The communication apparatus 1400 may include a communication unit 1401 and a processing unit 1402.

In this embodiment of this application, the communication unit 1401 may also be referred to as a transceiver unit, and may include a sending unit and/or a receiving unit, which are respectively configured to perform sending and receiving steps performed by the first apparatus or the second apparatus or the third apparatus in the foregoing method embodiments. The processing unit 1402 may be configured to read instructions and/or data in a storage module, to enable the communication apparatus 1400 to implement the foregoing method embodiments.

Optionally, the communication apparatus 1400 may further include a storage unit 1403. The storage unit 1403 is equivalent to the storage module, and may be configured to store the instructions and/or data.

The following describes in detail communication apparatuses provided in embodiments of this application with reference to FIG. 14 and FIG. 15. It should be understood that descriptions of apparatus embodiments correspond to the descriptions of the method embodiments. Therefore, for content that is not described in detail, refer to the foregoing method embodiments in FIG. 5, FIG. 6, and FIG. 10. For brevity, details are not described herein again.

The communication unit 1401 may also be referred to as a transceiver, a transceiver machine, a transceiver apparatus, or the like. The processing unit may also be referred to as a processor, a processing board, a processing module, a processing apparatus, or the like. Optionally, a component that is in the communication unit 1401 and that is configured to implement the receiving function may be considered as a receiving unit, and a component that is in the communication unit 1401 and that is configured to implement the sending function may be considered as a sending unit. That is, the communication unit 1401 includes the receiving unit and the sending unit. The communication unit sometimes may also be referred to as a transceiver machine, a transceiver, a transceiver circuit, or the like. The receiving unit sometimes may also be referred to as a receiver machine, a receiver, a receive circuit, or the like. The sending unit sometimes may also be referred to as a transmitter machine, a transmitter, a transmit circuit, or the like.

When the communication apparatus 1400 is the first apparatus in the procedure shown in FIG. 5 in the foregoing embodiment,
the processing unit 1402 determines weighting information N streams of sensing sequences of a second apparatus, where N is a positive integer; and
the communication unit 1401 is configured to send a first sensing frame, where the first sensing frame includes the weighting information.

When the communication apparatus 1400 is the second apparatus in the procedure shown in FIG. 5 in the foregoing embodiment,
the communication unit 1401 is configured to receive a first sensing frame from a first apparatus, where the first sensing frame includes weighting information N streams of sensing sequences of the second apparatus, and N is a positive integer;
the processing unit 1402 is configured to separately weight the N streams of sensing sequences based on the weighting information, to obtain the N streams of weighted sensing sequences; and
the communication unit 1401 is configured to send the N streams of weighted sensing sequences.

When the communication apparatus 1400 is the third apparatus in the procedure shown in FIG. 5 in the foregoing embodiment,
the communication unit 1401 is configured to receive a first sensing frame from a first apparatus, where the first sensing frame includes weighting information N streams of sensing sequences of a second apparatus, and N is a positive integer; and is further configured to receive the N streams of weighted sensing sequences from the second apparatus; and
the processing unit 1402 is configured to process the N streams of weighted sensing sequences based on the weighting information.

The foregoing is merely examples. The processing unit 1402 and the communication unit 1401 may further perform other functions. For more detailed descriptions, refer to related descriptions in the method embodiments shown in FIG. 5, FIG. 6, and FIG. 10. Details are not described herein again.

FIG. 15 shows a communication apparatus 1500 according to an embodiment of this application. The communication apparatus shown in FIG. 15 may be an implementation of a hardware circuit of the communication apparatus shown in FIG. 14. The communication apparatus 1500 may be applicable to the foregoing flowcharts, and performs functions of the first apparatus, the second apparatus, or the third apparatus in the foregoing method embodiments. For ease of description, FIG. 15 shows only main components of the communication apparatus.

As shown in FIG. 15, the communication apparatus 1500 includes a communication interface 1501 and a processor 1502. The communication interface 1501 and the processor 1502 are coupled to each other. It may be understood that the communication interface 1501 may be a transceiver or an input/output interface, or may be an interface circuit like a transceiver circuit. Optionally, the communication apparatus 1500 may further include a memory 1503, configured to store instructions executed by the processor 1502, store input data required by the processor 1502 to run the instructions, or store data generated after the processor 1502 runs the instructions.

When the communication apparatus 1500 is configured to implement the method shown in FIG. 5, the processor 1502 is configured to implement functions of the processing unit 1402, and the communication interface 1501 is configured to implement functions of the communication unit 1401 (including the receiving unit and/or the sending unit).

In this embodiment of this application, a specific connection medium between the communication interface 1501, the processor 1502, and the memory 1503 is not limited. In this embodiment of this application, the memory 1503, the processor 1502, and the communication interface 1501 are connected through a communication bus 1504 in FIG. 15. The communication bus 1504 is represented by using a thick line in FIG. 15. A connection manner between other components is merely an example for description, and is not limited thereto. The communication bus 1504 may be classified into an address bus, a data bus, a control bus, and the like. For ease of representation, only one thick line is used to represent the bus in FIG. 15, but this does not mean that there is only one bus or only one type of bus.

When the communication apparatus is a chip, FIG. 16 is a diagram of a simplified apparatus structure of the chip. The chip 1600 includes an interface circuit 1601 and one or more processors 1602. Optionally, the chip 1600 may further include a bus. The processor 1602 may be an integrated circuit chip and has a signal processing capability.

In an implementation process, steps in the foregoing communication method may be implemented through a hardware integrated logic circuit in the processor 1602, or by using instructions in a form of software. The processor 1602 may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor may implement or perform the methods and steps that are disclosed in embodiments of this application. The general-purpose processor may be a microprocessor, or the processor may be any conventional processor or the like.

The interface circuit 1601 may be configured to send or receive data, instructions, or information. The processor 1602 may perform processing by using the data, the instructions, or other information received by the interface circuit 1601, and may send processed information through the interface circuit 1601.

Optionally, the chip further includes a memory 1603. The memory 1603 may include a read-only memory and a random access memory, and provide operation instructions and data for the processor. A part of the memory 1603 may include a non-volatile random access memory (NVRAM).

Optionally, the memory stores an executable software module or a data structure, and the processor may perform a corresponding operation by invoking the operation instructions stored in the memory (the operation instructions may be stored in an operating system).

Optionally, the chip may be used in the first apparatus, the second apparatus, or the third apparatus in embodiments of this application. Optionally, the interface circuit 1601 may be configured to output an execution result of the processor 1602. For the communication methods provided in one or more embodiments of this application, refer to the foregoing embodiments. Details are not described herein again.

It should be noted that functions corresponding to each of the interface circuit 1601 and the processor 1602 may be implemented by using a hardware design, may be implemented by using a software design, or may be implemented by using a combination of software and hardware. This is not limited herein.

An embodiment of this application further provides a computer-readable storage medium. The computer-readable storage medium stores computer instructions used to implement the method performed by the first apparatus, the second apparatus, or the third apparatus in the foregoing method embodiments.

For example, when a computer program is executed by a computer, the computer can implement the method performed by the first apparatus, the second apparatus, or the third apparatus in the foregoing method embodiments.

An embodiment of this application further provides a computer program product including instructions. When the instructions are executed by a computer, the computer is enabled to implement the method performed by the first apparatus, the second apparatus, or the third apparatus in the foregoing method embodiments.

An embodiment of this application further provides a chip apparatus, including a processor, configured to invoke a computer program or computer instructions stored in a memory, so that the processor performs the communication methods in embodiments shown in FIG. 5 and FIG. 6 and FIG. 10.

In a possible implementation, an input of the chip apparatus corresponds to a receiving operation in embodiments shown in FIG. 5 and FIG. 6 and FIG. 10, and an output of the chip apparatus corresponds to a sending operation in embodiments shown in FIG. 5 and FIG. 6 and FIG. 10.

Optionally, the processor is coupled to the memory through an interface.

Optionally, the chip apparatus further includes the memory. The memory stores the computer program or the computer instructions.

The processor mentioned in any one of the foregoing may be a general central processing unit, a microprocessor, an application-specific integrated circuit (application-specific integrated circuit, ASIC), or one or more integrated circuits configured to control program execution of the communication method in embodiments shown in FIG. 5 and FIG. 10. The memory mentioned in any one of the foregoing may be a read-only memory (read-only memory, ROM), another type of static storage device that can store static information and instructions, a random access memory (random access memory, RAM), or the like.

It should be noted that for ease and brevity of description, for explanations and beneficial effect of related content of any one of the communication apparatuses provided above, refer to the corresponding communication method embodiments provided above. Details are not described herein again.

In this application, a hardware layer, an operating system layer running above the hardware layer, and an application layer running above the operating system layer may be further included between communication apparatuses. The hardware layer may include hardware such as a central processing unit (central processing unit, CPU), a memory management module (memory management unit, MMU), and a memory (also referred to as a main memory). An operating system at the operating system layer may be any one or more computer operating systems that implement service processing by using a process (process), for example, a Linux operating system, a Unix operating system, an Android operating system, an iOS operating system, or a Windows operating system. The application layer may include applications such as a browser, an address book, word processing software, and instant messaging software.

Division into the modules in embodiments of this application is an example, is merely division into logical functions, and may be other division during actual implementation. In addition, functional modules in embodiments of this application may be integrated into one processor, or may exist alone physically, or two or more modules may be integrated into one module. The integrated module may be implemented in a form of hardware, or may be implemented in a form of a software functional module.

Through descriptions of the foregoing implementations, a person skilled in the art may clearly understand that embodiments of this application may be implemented by hardware, firmware or a combination thereof. When this application is implemented by software, the foregoing functions may be stored in a computer-readable medium or transmitted as one or more instructions or code in the computer-readable medium. The computer-readable medium includes a computer storage medium and a communication medium, where the communication medium includes any medium that enables a computer program to be transmitted from one place to another. The storage medium may be any available medium accessible to a computer. Examples of the computer-readable medium include but are not limited to: a RAM, a ROM, an electrically erasable programmable read only memory (electrically erasable programmable read only memory, EEPROM), a compact disc read-only memory (compact disc read-Only memory, CD-ROM) or another optical disc storage, a disk storage medium or another disk storage device, or any other medium that can be used to carry or store expected program code in an instruction or data structure form and can be accessed by a computer. In addition, any connection may be properly defined as a computer-readable medium. For example, if software is transmitted from a website, a server, or another remote source by using a coaxial cable, an optical fiber and optical cable, a twisted pair, a digital subscriber line (digital subscriber line, DSL), or wireless technologies such as infrared, radio, and microwave, the coaxial cable, the optical fiber and optical cable, the twisted pair, the DSL, or the wireless technologies such as infrared, radio, and microwave are included in a definition of a medium to which the coaxial cable, the optical fiber and optical cable, the twisted pair, the DSL, or the wireless technologies such as the infrared ray, the radio, and the microwave belong. For example, a disk (disk) and a disc (disc) used in embodiments of this application include a compact disc (compact disc, CD), a laser disc, an optical disc, a digital video disc (digital video disc, DVD), a floppy disk and a Blu-ray disc. The disk generally copies data by a magnetic means, and the disc copies data optically by a laser means. The foregoing combination should also be included in the protection scope of the computer-readable medium.

In summary, the foregoing descriptions are merely embodiments of this application, and are not intended to limit the protection scope of this application. Any modification, equivalent substitution, and improvement made based on the disclosure of this application shall fall within the protection scope of this application.

1. A communication method, wherein the method comprises:
determining, by a first apparatus, weighting information N streams of sensing sequences of a second apparatus, wherein N is a positive integer; and
sending, by the first apparatus, a first sensing frame, wherein the first sensing frame comprises the weighting information.

2. The method according to claim 1, wherein before determining, by the first apparatus, the weighting information of the second apparatus, the method further comprises:
sending, by the first apparatus, a request message to the second apparatus, wherein the request message is used to request to set up sensing measurement, the request message comprises at least one sensing subelement, and each sensing subelement corresponds to a weighting matrix.

3. The method according to claim 1, wherein before determining, by the first apparatus, the weighting information of the second apparatus, the method further comprises:
sending, by the first apparatus, a request message to the second apparatus, wherein the request message is used to request to set up sensing measurement, the request message comprises at least one sensing subelement, and each sensing subelement corresponds to a phase rotation codebook of a sensing sequence.

4. The method according to claim 2, wherein the request message further comprises first indication information, and the first indication information indicates to use a weighted collaborative sensing mode.

5. The method according to claim 4, wherein the method further comprises:
receiving, by the first apparatus, a response message from the second apparatus, wherein the response message indicates that the second apparatus supports to use the weighted collaborative sensing mode.

6. The method according to claim 2, wherein before sending, by the first apparatus, the first sensing frame, the method further comprises:
sending, by the first apparatus, a second sensing frame to the second apparatus, wherein the second sensing frame comprises second indication information, and the second indication information indicates to perform weighted transmission on the sensing sequence.

7. The method according to claim 2, wherein the sensing subelement comprises a weighting matrix indication field, and the weighting matrix indication field indicates the corresponding weighting matrix.

8. The method according to claim 7, wherein the weighting matrix field comprises X bits, X is a positive integer, the X bits comprise three parts, a first part indicates a weighting matrix of 2×2, a second part indicates a weighting matrix of 4×4, and the second part and a third part jointly indicate a weighting matrix of 8×8.

9. The method according to claim 3, wherein the sensing subelement comprises a codebook indication field, and the codebook indication field indicates the phase rotation codebook of the sensing sequence.

10. The method according to claim 9, wherein the codebook indication field comprises Y bits, the Y bits comprise L groups of bits, each group of bits indicates coding of one phase rotation manner, and Y and L are positive integers.

11. A first apparatus, comprising a processor and a memory, wherein
the processor is configured to execute instructions stored in the memory, to cause the first apparatus to:
determine weighting information N streams of sensing sequences of a second apparatus, wherein N is a positive integer; and
send a first sensing frame, wherein the first sensing frame comprises the weighting information.

12. The first apparatus according to claim 11, wherein the processor is configured to execute the instructions to further cause the first apparatus to:
send a request message to the second apparatus before determining the weighting information of the second apparatus, wherein the request message is used to request to set up sensing measurement, the request message comprises at least one sensing subelement, and each sensing subelement corresponds to a weighting matrix.

13. The first apparatus according to claim 11, wherein the processor is configured to execute the instructions to further cause the first apparatus to:
send a request message to the second apparatus before determining the weighting information of the second apparatus, wherein the request message is used to request to set up sensing measurement, the request message comprises at least one sensing subelement, and each sensing subelement corresponds to a phase rotation codebook of a sensing sequence.

14. The first apparatus according to claim 12, wherein the request message further comprises first indication information, and the first indication information indicates to use a weighted collaborative sensing mode.

15. The first apparatus according to claim 14, wherein the processor is configured to execute the instructions to further cause the first apparatus to:
receive a response message from the second apparatus, wherein the response message indicates that the second apparatus supports to use the weighted collaborative sensing mode.

16. The first apparatus according to claim 12, wherein the processor is configured to execute the instructions to further cause the first apparatus to:
sending a second sensing frame to the second apparatus before sending the first sensing frame, wherein the second sensing frame comprises second indication information, and the second indication information indicates to perform weighted transmission on the sensing sequence.

17. The first apparatus according to claim 12, wherein the sensing subelement comprises a weighting matrix indication field, and the weighting matrix indication field indicates the corresponding weighting matrix.

18. The first apparatus according to claim 17, wherein the weighting matrix field comprises X bits, X is a positive integer, the X bits comprise three parts, a first part indicates a weighting matrix of 2×2, a second part indicates a weighting matrix of 4×4, and the second part and a third part jointly indicate a weighting matrix of 8×8.

19. The first apparatus according to claim 13, wherein the sensing subelement comprises a codebook indication field, and the codebook indication field indicates the phase rotation codebook of the sensing sequence.

20. The first apparatus according to claim 19, wherein the codebook indication field comprises Y bits, the Y bits comprise L groups of bits, each group of bits indicates coding of one phase rotation manner, and Y and L are positive integers.
